(19) United States
(12) Patent Application Publication
(10) Pub. No.: US 2016/0232150 A1
(43) Pub. Date: Aug. 11, 2016

(54) Method and System for Generating a User Activity Grid Table

(71) Applicant: SINGAPORE TELECOMMUNICATIONS LIMITED, Singapore (SG)

(72) Inventors: James Christian Decraene, Singapore (SG); Amy Xuemei Shi-Nash, Singapore (SG)

(73) Assignee: Singapore Telecomunications Limited, Singapore (SG)

(21) Appl. No.: 15/022,517

(22) PCT Filed: Mar. 18, 2014
(86) PCT No.: PCT/SG2014/000135

§ 371 Date: Mar. 16, 2016

(51) Int. Cl. G06F 17/24; G06F 17/30

(52) U.S. Cl. CPC G06F 17/245; G06F 17/30601; G06F 17/30371; G06F 17/30241

(57) ABSTRACT

A system for generating a user activity grid table is provided. The system includes processes for retrieving raw data from a server and processing this data to generate a user activity grid table that displays the timings that a user or a plurality of users spends in a particular geographical location, at a particular website or watching a particular channel.

### FIELD OF THE INVENTION

This invention relates to a system for generating a user activity grid table. More particularly, this invention relates to a system and method for retrieving raw data from a server and processing the raw data to generate a user activity table that displays the timings that a user or a plurality of users spends in a particular geographical location, at a particular website or watching a particular channel. Still more particularly, this invention relates to a system and method that further allows the generation of at least one user activity table that displays the timings that a mobile device user spends talking, messaging or using cellular data in a particular geographical location; the timings that a user or a plurality of users spends watching a particular program or a particular type of program on a particular channel; and the timings that a user or a plurality of users spends uploading and/or downloading a particular volume of data from a specific website.

### SUMMARY OF THE PRIOR ART

Due to the increasing availability of location data provided from both global positioning systems (GPS) and mobile telephone usage, it has become easier for studies and analysis on human daily activity patterns to be performed. The knowledge of the places that an individual regularly visits, when the individual visits, how often the individual visits, during which days of the months and at what times of the day etc. may be exploited for the provision of custom services, targeted advertising offers, etc. In general, by knowing the locations/websites an individual regularly visits or channels that an individual regularly watches or when the individual visits/watches; allows for the personalization of a commercial suite of activities targeted to that particular individual.

Characterizing a device user's daily activities without loss of spatial or temporal details remains a non-trivial task despite the wide availability of spatiotemporal data generated by telecommunication companies and various locations based social networks. The analysing of human mobility and activities at the aggregated level provides a deeper understanding of societies. Some tasks such as user profiling or service personalization are de facto conducted at the individual level where a deeper understanding of spatiotemporal patterns is necessary. Even though it is recognized that this is an important area, few approaches have been proposed to characterize people at the individual level where spatiotemporal details are conserved.

Present approaches tend to utilize GPS data combined with information collected from the particular user. However, the downside to such approaches is that relevant locations have to be provided either by the user or by a GPS navigation system. Such approaches do not allow for the constant collection of raw cellular data and for the analysis of this raw data to generate an individual's user profile.

For the above reasons, those skilled in the art are constantly striving to come up with a system to analyse a user's daily activities based on raw cellular data as transmitted from the user's mobile devices with no user interaction required.

### SUMMARY OF THE INVENTION

The above and other problems are solved and an advance in the art is made by systems and methods provided by embodiments in accordance with the invention. A first advantage of embodiments of systems and methods in accordance with this invention is that visual representations may be generated based on raw data transmitted from devices. The manner in which these visual representations are presented allow for a device user's daily activities or multiple mobile device users' daily activities to be effectively and efficiently interpreted. A second advantage of embodiments of systems and methods in accordance with this invention is that the system is able to process and generate visual representations of large amounts of raw data without losing granularity. A third advantage of embodiments of systems and methods in accordance with this invention is that specific aspects of a device user's daily life or certain traits of a plurality of device users' daily lives may be visually represented thereby providing insight into the user's or users' lifestyles and activities.

The above advantages are provided by embodiments of a system in accordance with the invention operating in the following manner. The system first generates and displays a first table having a plurality of grids, wherein each grid represents a timeslot. Each of these timeslots includes a day component and a time component. The system then selects a first set of validated entries wherein each entry of this first set of validated entries includes a timestamp. Each of these timestamps includes a day component and a time component. The system then links the selected first set of validated entries to the first table and marks grids in the first table that match with timestamps of each of the linked first set of validated entries, wherein the grids are marked using a graduated tone marking schema. In accordance with further embodiments of the system, the graduated tone marking schema comprises a colorimetric marking schema.

In accordance with embodiments of the invention, the system selects the first set of validated entries in the following manner. The system first retrieves a first set of entries from a server, wherein each entry in the first set of entries comprises a latitudinal and longitudinal coordinate and a timestamp. Each entry in the first set of entries are then grouped into one of a plurality of clusters according to the latitudinal and longitudinal coordinate of each entry, wherein each of the plurality of clusters is associated with a range of latitudinal and longitudinal coordinates. The system then selects one of the plurality of clusters, and verifies each entry in the selected one of the plurality of clusters. Each verified entry is then validated by the system.

In accordance with embodiments of the invention, the system selects a map from a database, wherein a range of latitudinal and longitudinal coordinates on the map corresponds to the range of latitudinal and longitudinal coordinates associated with the selected one of the plurality of clusters. The latitudinal and longitudinal coordinates of validated entries are then plotted on the map and the map is then displayed. In accordance with further embodiments of the system, the latitudinal and longitudinal coordinates of validated entries are plotted on the map using a colorimetric plotting schema.

In accordance with embodiments of the invention, the system groups each entry in the first set of entries in the following manner. The system first selects an entry from the first set of entries. The system then obtains a latitudinal and longitudinal coordinate corresponding to the selected entry and the system then determines whether the obtained latitudinal and longitudinal coordinate matches a latitudinal and longitudinal coordinate range associated with one of the plurality of clusters. In response to a determination of a match between the obtained latitudinal and longitudinal coordinate and the latitudinal and longitudinal coordinate range associated with the cluster, the system associates the selected entry with the existing cluster.

In accordance with embodiments of the invention, the system verifies each entry in the selected one of the plurality of clusters in the following manner. The system groups the entries into timestamp groups and subsequently determines the validity of the timestamp groups.

In accordance with embodiments of the invention, the system groups the entries into timestamp groups in the following manner. The system first selects an entry from the cluster and then obtains a timestamp corresponding to the selected entry. The system then determines whether the obtained timestamp matches a timestamp range of a timestamp group. If there is a match between the obtained timestamp and the timestamp range of the timestamp group, the system associates the selected entry with the timestamp group.

In accordance with embodiments of the invention, the system determines the validity of the timestamp groups in the following manner. The system first selects a timestamp group and subsequently determines whether the number of entries in the selected timestamp group exceeds a minimum number threshold. The system then validates entries in the timestamp group in response to a determination the number of entries in the selected timestamp group exceeds the minimum number threshold.

In accordance with embodiments of the invention, the system verifies each entry in the selected one of the plurality of clusters in the following manner. The system first selects an entry from the linked cluster. A record of cellular data usage corresponding to the selected entry is then obtained. The system then determines whether the record of cellular data usage exceeds a minimum data usage threshold. The entry is validated in response to a determination the record of cellular data usage exceeds the minimum data usage threshold. The system repeats these processes until all the entries in the cluster have been verified.

In accordance with embodiments of the invention, the system verifies each entry in the selected one of the plurality of clusters in the following manner. The system first selects an entry from the linked cluster. A record of voice usage corresponding to the selected entry is then obtained. The system then determines whether the record of voice usage exceeds a minimum voice usage threshold. The entry is validated in response to a determination the record of voice usage exceeds the minimum voice usage threshold. The system repeats these processes until all the entries in the cluster have been verified.

In accordance with embodiments of the invention, the system retrieves the first set of entries from the server in the following manner. The system first segregates each entry in the first set of entries into one of a plurality of groups according to a mobile number of each entry, wherein each of the plurality of groups is associated with a mobile number. The system then selects one of the plurality of groups that corresponds to a first mobile number and then excludes the other groups from the first set of entries.

In accordance with embodiments of the invention, the system selects the first set of validated entries in the following manner. The system first retrieves a first set of entries from a server, wherein each entry in the first set of entries comprises a channel and a timestamp. The server then groups each entry in the first set of entries into one of a plurality of clusters according to the channel of each entry, wherein each of the plurality of clusters is associated with a channel. The system then selects one of the plurality of clusters and verifies each entry in the selected one of the plurality of clusters. Each verified entry is then validated by the system.

In accordance with embodiments of the invention, the system groups each entry in the first set of entries in the following manner. The system selects an entry from the first set of entries and then obtains a channel corresponding to the selected entry. The system then determines whether the obtained channel matches a channel associated with one of the plurality of clusters. The selected entry is then associated with the existing cluster in response to a determination of a match between the obtained channel and the channel associated with the cluster.

In accordance with embodiments of the invention, the system verifies each entry in the selected one of the plurality of clusters in the following manner. The system selects an entry from the linked cluster and obtains a record of program language corresponding to the selected entry. The system then determines whether the record of the program language matches a first program language. If the program language matches the first program language, the entry is validated. The system repeats these processes until all the entries in the cluster have been verified.

In accordance with embodiments of the invention, the system verifies each entry in the selected one of the plurality of clusters in the following manner. The system selects an entry from the linked cluster and obtains a record of title corresponding to the selected entry. The system then determines whether the record of the title matches a first title. If the title matches the first title, the entry is validated. The system repeats these processes until all the entries in the cluster have been verified.

In accordance with embodiments of the invention, the system selects the first set of validated entries in the following manner. The system first retrieves a first set of entries from a server, wherein each entry in the first set of entries comprises a universal resource locator and a timestamp. The server then groups each entry in the first set of entries into one of a plurality of clusters according to the universal resource locator of each entry, wherein each of the plurality of clusters is associated with a universal resource locator. The system then selects one of the plurality of clusters and verifies each entry in the selected one of the plurality of clusters. Each verified entry is then validated by the system.

In accordance with embodiments of the invention, the system groups each entry in the first set of entries in the following manner. The system selects an entry from the first set of entries and then obtains a universal resource locator corresponding to the selected entry. The system then determines whether the obtained universal resource locator matches a universal resource locator associated with one of the plurality of clusters. The selected entry is then associated with the existing cluster in response to a determination of a match between the obtained universal resource locator and the universal resource locator associated with the cluster.

In accordance with embodiments of the invention, the system verifies each entry in the selected one of the plurality of clusters in the following manner. The system selects an entry from the linked cluster and obtains a record of data volume corresponding to the selected entry. The system then determines whether the record of the data volume exceeds a minimum data volume threshold. If the record of the data volume exceeds the minimum data threshold, the entry is validated. The system repeats these processes until all the entries in the cluster have been verified.

In accordance with embodiments of the invention, the system further generates and displays a second table having a plurality of grids, wherein each grid represents a timeslot, each timeslot having a day component and a time component. The system then selects a second set of validated entries wherein each entry of this second set of validated entries comprises a timestamp, each timestamp having a day component and a time component. The system then links the selected second set of validated entries to the second table; and marks grids in the second table that match with timestamps of each of the linked second set of validated entries, wherein the grids are marked using a graduated tone marking schema.

In accordance with embodiments of the invention, the system further identifies a location of the selected cluster by comparing the range of the latitudinal and longitudinal coordinates associated with the selected cluster to geographical records contained within a geographical map database. The system then determines an activity associated with the selected cluster based on the timestamps of the validated entries.

### BRIEF DESCRIPTION OF THE DRAWINGS

The above advantages and features in accordance with this invention are described in the following detailed description and are shown in the following drawings:

FIG. 1 illustrating a schematic of a system in accordance with an embodiment of the invention;

FIG. 2 illustrating a block diagram representative of processing systems providing embodiments in accordance with embodiments of the invention;

FIG. 3a illustrating a plurality of entries as obtained from a server in accordance with embodiments of the invention wherein each entry includes a latitudinal and longitudinal coordinate and an associated timestamp;

FIG. 3b illustrating a plurality of entries as obtained from a server in accordance with embodiments of the invention wherein each entry includes a latitudinal and longitudinal coordinate, an associated timestamp and a mobile number;

FIG. 3c illustrating a plurality of entries as obtained from a server in accordance with embodiments of the invention wherein each entry includes a channel record and an associated timestamp;

FIG. 3d illustrating a plurality of entries as obtained from a server in accordance with embodiments of the invention wherein each entry includes a universal resource locator (URL) record and an associated timestamp;

FIG. 4 illustrating the plurality of entries in FIG. 3b being segregated into groups according to the mobile number of each entry;

FIG. 5 illustrating the plurality of entries in FIG. 3a being grouped into clusters according to the latitudinal and longitudinal coordinate of each entry;

FIG. 6 illustrating the plurality of entries in FIG. 3c being grouped into clusters according to the channel record of each entry;

FIG. 7 illustrating the plurality of entries in FIG. 3d being grouped into clusters according to the universal resource locator record of each entry;

FIG. 8 illustrating a cluster of FIG. 5 being further grouped into timestamp groups in accordance with embodiments of the invention;

FIG. 9 illustrating a generated table having a plurality of grids in accordance with embodiments of the invention wherein the generated table is to be linked to a cluster having a range of latitudinal and longitudinal coordinates;

FIGS. 10a and 10b illustrating a grid table that is linked to a cluster with the table having a marked timeslot in accordance with embodiments of the invention;

FIGS. 11a, 11b and 11c illustrating examples of marked grid tables in accordance with embodiments of the invention;

FIG. 12 illustrating a marked grid table and a map having plots in accordance with embodiments of the invention;

FIG. 13a illustrating a generated table having a plurality of grids in accordance with embodiments of the invention wherein the generated table is to be linked to a cluster having a record of a channel;

FIG. 13b illustrating an example of a marked grid table in accordance with embodiments of the invention wherein the table in this illustration is linked to a cluster having a record of Channel2;

FIG. 13c illustrating an example of a marked grid table in accordance with embodiments of the invention wherein the table in this illustration is linked to a cluster having a record of Channel3;

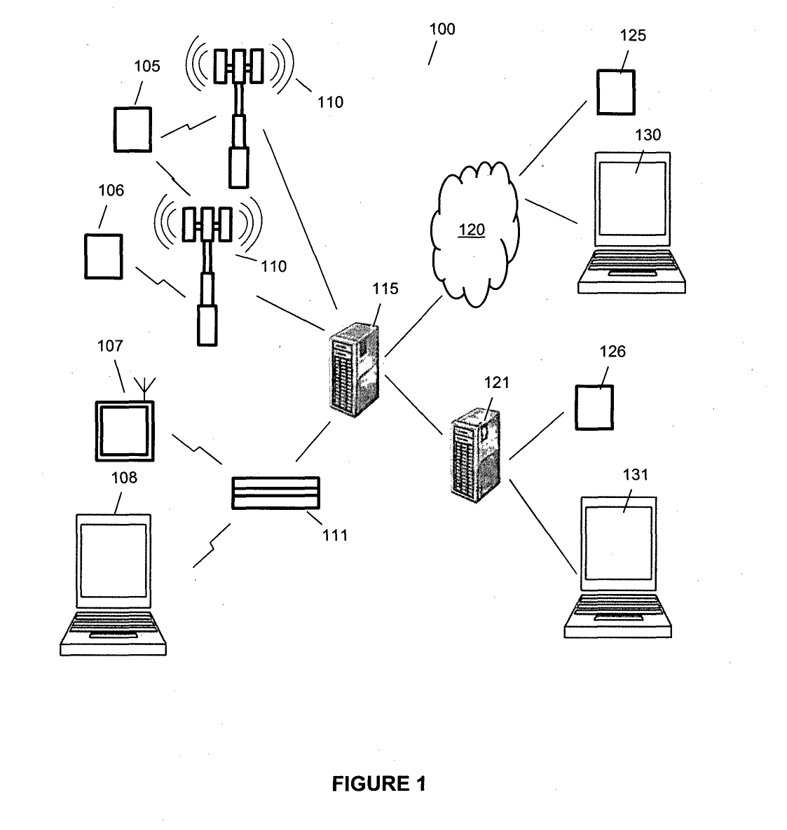

FIG. 1.4a illustrating a generated table having a plurality of grids in accordance with embodiments of the invention wherein the generated table is to be linked to a cluster having a record of a universal resource locator;

FIG. 14b illustrating an example of a marked grid table in accordance with embodiments of the invention wherein the table in this illustration is linked to a cluster having a record of Website4;

FIG. 14c illustrating an example of a marked grid table in accordance with embodiments of the invention wherein the table in this illustration is linked to a cluster having a record of Website2;

FIG. 15 illustrating a flow diagram of a process for generating a user activity grid table in accordance with embodiments of the invention;

FIG. 16 illustrating a flow diagram of a process for grouping entries into clusters in accordance with embodiments of the invention;

FIG. 17 illustrating a flow diagram of a process for grouping entries into timestamp groups and for determining the validity of the timestamp groups in accordance with embodiments of the invention;

FIG. 18 illustrating a flow diagram of a process for validating a data usage parameter in the entries of a cluster in accordance with embodiments of the invention;

FIG. 19 illustrating a flow diagram of a process for validating a short message service usage parameter in the entries of a cluster in accordance with embodiments of the invention;

FIG. 20 illustrating a flow diagram of a process for validating a voice usage parameter in the entries of a cluster in accordance with embodiments of the invention;

FIG. 21 illustrating a flow diagram of a process for validating a program language parameter in the entries of a cluster in accordance with embodiments of the invention;

FIG. 22 illustrating a flow diagram of a process for validating a title parameter in the entries of a cluster in accordance with embodiments of the invention;

FIG. 23 illustrating a flow diagram of a process for validating a data volume parameter in the entries of a cluster in accordance with embodiments of the invention;

FIG. 24 illustrating a flow diagram of a process for marking grids in a linked table in accordance with embodiments of this invention;

FIG. 25 illustrating a flow diagram of a process for plotting the latitudinal and longitudinal coordinates of validated entries on a map in accordance with embodiments of the invention; and

FIG. 26 illustrating a flow diagram of a process for segregating entries into groups according to the mobile number of each entry in accordance with embodiments of the invention.

### DETAILED DESCRIPTION

This invention relates to a system for generating a user activity grid table. More particularly, this invention relates to a system and method for retrieving raw data from a server and processing the raw data to generate a user activity grid table that displays the timings in which a user or a plurality of users carries out a particular activity. Still more particularly, this invention relates to a system and method that further allows the generation of a user activity grid table that displays the timings in which a device user or a plurality of device users spends talking, messaging or using cellular data in a particular geographical location. Further, this invention is also able to plot the corresponding geographical locations on a map. This invention also relates to a system and method that further allows the generation of a user activity grid table that displays the timings in which a user or a plurality of users accesses a website or watches a particular television channel. Further, this invention is able to display the timings at which a user or a plurality of users watches a particular program based on the language of the program or the title of the program. This invention is also able to display the timings at which a user or a plurality of users downloads and/or uploads a particular volume of data from a website.

A system in accordance with embodiments of this invention is configured to generate visual representations based on raw data. This raw data may include spatiotemporal data such as the location of a mobile device at a particular time. The spatiotemporal data may include the longitudinal and latitudinal coordinates of a mobile device together with the timestamps associated with each coordinate entry. In accordance with embodiments of the invention, the raw data may include other parameters such as the mobile device's number, a record of the mobile device's cellular data usage, a record of the mobile device's voice usage or a record of the mobile device's short message service usage all at a particular time.

In embodiments of the invention, this raw data may comprise temporal data associated with a television channel or temporal data associated with a website. The temporal data associated with the television channel may be further associated with other parameters such as a record of the program's language and a record of the program's title. Similarly, the temporal data associated with the website may be further associated with other parameters such as the volume of data being uploaded to the website or downloaded from the website.

In addition to the above, the system is able to process and display large amounts of raw data in an intelligible manner without losing granularity as the grids of the tables are marked using a graduated tone marking scheme that darkens as more marks are applied to a particular grid. Conversely, if lesser marks are applied to a particular grid, the grid would be lightly marked as compared to other grids. The manner in which these visual representations are presented allow for a user's daily activities or a plurality of users' daily activities to be effectively and efficiently presented and interpreted thereby providing insight into the user's or users' lifestyles and activities.

FIG. 1 illustrates network 100 that includes devices that executes processes to provide a user activity grid table generation system in accordance with this invention. Network 100 includes servers 115, 121, cloud computing server 120, client devices 125, 126 and computers 130, 131. Network 100 is, a communications network that allows processing systems to communicate with one another either through wired means, wireless means or a combination of both. Wired means may include a wired network such as a wide area network (WAN) or a local area network (LAN), while wireless means includes connections to a network via Radio Frequency (RF) signals, infrared signals, or any other means of wireless transmissions.

When mobile devices 105, 106 are switched on, mobile devices 105, 106 constantly transmit raw data to base station towers 110 and receive raw data from base station towers 110. The raw data transmitted between mobile devices 105, 106 and base station towers 110 includes the geographical location of each respective mobile device at a particular time, the mobile number associated with each respective mobile device, the voice usage of each respective mobile device at a particular time, the short message service usage of each respective mobile device at a particular time, and/or the cellular data usage of each respective mobile device at a particular time.

The geographical location of the mobile device may be in the form of longitudinal and latitudinal coordinates. Base station towers 110, in turn, transmit all the received raw data to server 115 either directly or via relays such as cellular repeaters. Server 115 then stores the received data in databases as data entries. These databases may be a part of server 115 or these databases may be located at another location and linked to server 115 through a communications network such as, but not limited to, the Internet. One skilled in the art will recognize that the raw data transmitted between mobile devices 105, 106 and base stations towers 110 and subsequently stored by server 115 may include other parameters without departing from this invention.

Similarly, when a channel on television 107 is selected and/or when a website on computer 108 is accessed, raw data is transmitted between television 107, computer 108 and modem 111. Modem 111 may comprise a digital subscriber line (DSL) modem or any type of device that may be used to connect television 107 and/or computer 108 to the Internet. The raw data transmitted between television 107, computer 108 and modem 111 includes the channel watched by a user, the language and/or title of the program at a particular time, and the website accessed by a user together with the amount of data uploaded to and/or downloaded from the website at a particular time. One skilled in the art will recognize that the raw data transmitted between television 107, computer 108 and modem 111 and subsequently stored by server 115 may include other parameters without departing from this invention.

Modem 111 in turn transmits all the received raw data to server 115 either directly or via relays such as the cellular repeaters used to transmit data between towers 110 and server 115. Server 115 then stores the received data from modem 111 in databases as data entries. Similarly, these databases may be a part of server 115 or these databases may be located at another location and linked to server 115 through a communications network such as, but not limited to, the Internet. One skilled in the art will recognize that the raw data transmitted between television 107, computer 108, modem 111 and subsequently stored by server 115 may include other parameters without departing from this invention.

Server 121 or cloud computer server system 120 comprises one or more servers that are connected to one or more storage mediums to store and process data received from various sources. These storage mediums may be a part of servers 120, 121 or these storage mediums may be located at another location and linked to servers 120, 121 through a communications network such as, but not limited to, the Internet.

Server 121 or cloud computing server system 120 are each able to store data and execute various processes such as retrieving the data entries from server 115, transmitting data to and receiving data from computers 130, 131 or client devices 125, 126 and perform other types of computer related processes. Client devices 125, 126 may include smart phones, laptops, tablets, and all other types of mobile devices that have a display. Computers 130, 131 are traditional laptop or desktop computer systems that are connected to server 121 or cloud computing server 120 via either a wired or wireless connection. One skilled in the art will recognize that computers 130, 131 and client devices 125, and 126 are only provided as examples and other types of devices with displays may be used to interact with servers 115, 121 or cloud computing server 120 to display content without departing from this invention.

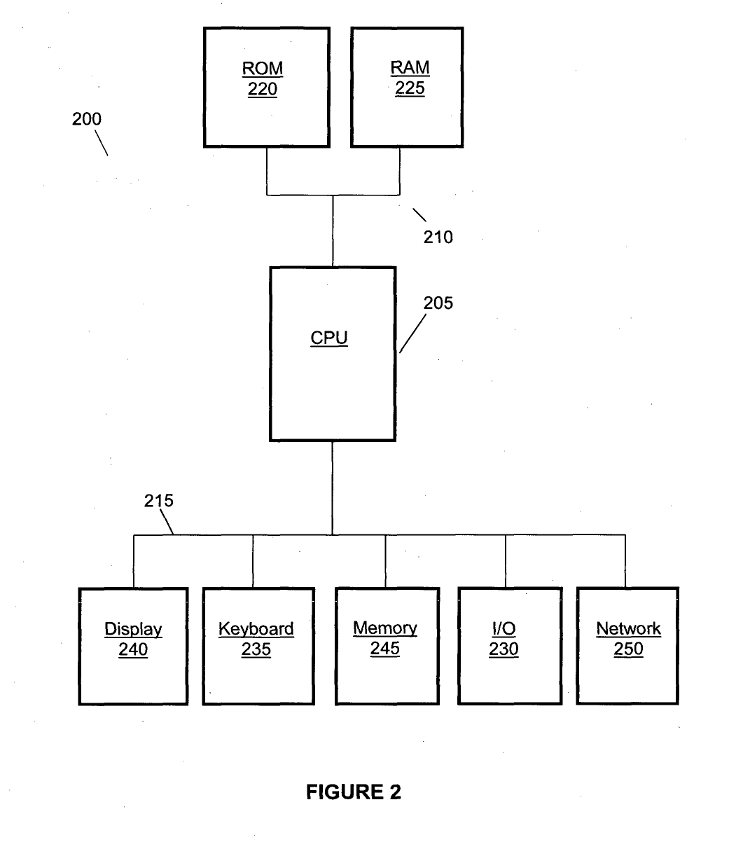

Processes provided by instructions stored by a media are executed by a processing system in a computer system. A computer system may be provided in one or more servers to provide this invention. The instructions may be stored as firmware, hardware, or software. FIG. 2 illustrates an example of a processing system. Processing system 200 may be the processing system in the servers that execute the instructions to perform the processes for providing a method and/or system in accordance with embodiments of this invention. One skilled in the art will recognize that the exact configuration of each processing system may be different and the exact configuration of the processing system in each device may vary and FIG. 2 is given by way of example only.

Processing system 200 includes Central Processing Unit (CPU) 205. CPU 205 is a processor, microprocessor, or any combination of processors and microprocessors that execute instructions to perform the processes in accordance with the present invention. CPU 205 connects to memory bus 210 and Input/Output (I/O) bus 215. Memory bus 210 connects CPU 205 to memories 220 and 225 to transmit data and instructions between memories 220, 225 and CPU 205. I/O bus 215 connects CPU 205 to peripheral devices to transmit data between CPU 205 and the peripheral devices. One skilled in the art will recognize that I/O bus 215 and memory bus 210 may be combined into one bus or subdivided into many other busses and the exact configuration is left to those skilled in the art.

A non-volatile memory 220, such as a Read Only Memory (ROM), is connected to memory bus 210. Non-volatile memory 220 stores instructions and data needed to operate various sub-systems of processing system 200 and to boot the system at start-up. One skilled in the art will recognize that any number of types of memory may be used to perform this function.

A volatile memory 225, such as Random Access Memory (RAM), is also connected to memory bus 210. Volatile memory 225 stores the instructions and data needed by CPU 205 to perform software instructions for processes such as the processes required for providing a system in accordance with embodiments of this invention. One skilled in the art will recognize that any number of types of memory may be used as volatile memory and the exact type used is left as a design choice to those skilled in the art.

I/O device 230, keyboard 235, display 240, memory 245, network device 250 and any number of other peripheral devices connect to I/O bus 215 to exchange data with CPU 205 for use in applications being executed by CPU 205. I/O device 230 is any device that transmits and/or receives data from CPU 205. Keyboard 235 is a specific type of I/O that receives user input and transmits the input to CPU 205. Display 240 receives display data from CPU 205 and display images on a screen for a user to see. Memory 245 is a device that transmits and receives data to and from CPU 205 for storing data to a media. Network device 250 connects CPU 205 to a network for transmission of data to and from other processing systems.

Embodiments of the present invention utilize raw data from a user's device to generate visual representations of the user's daily activities. The embodiments also provide for raw data from one or more users' devices to be visually represented if so required. The raw data transmitted from base station towers or from modems to a server may be stored as one or more entries in the server's database. Each of these entries includes various parameters and the timestamp associated with the entry. Each timestamp includes a date component and a time component. The date component may be compared with a calendar stored in a server's database to determine the day corresponding to the particular date component. In other words, the data component may be converted by the system into a day component as well. For example, if the date component states 1 Jan. 2014, by comparing this date with a calendar stored in a server's database, the system will be able to ascertain that this date corresponds to Wednesday and the server's entries may be updated accordingly as and when required.

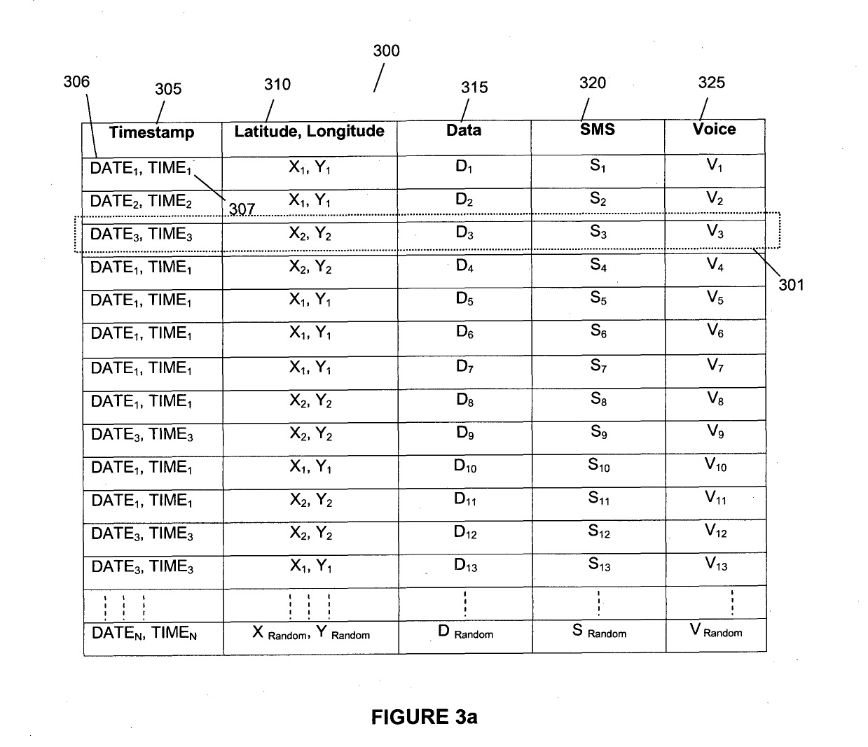

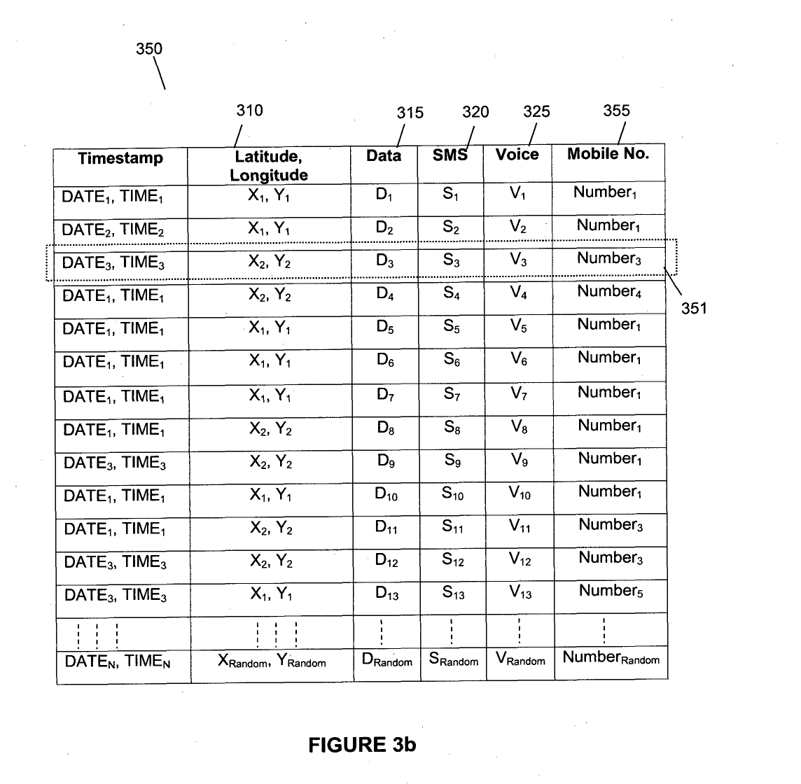

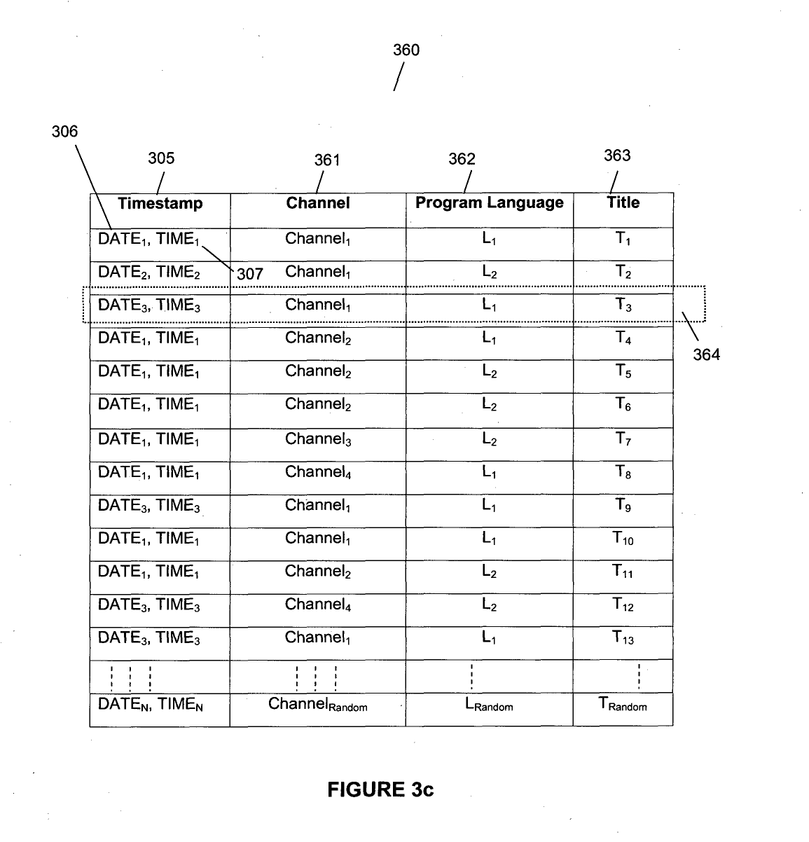

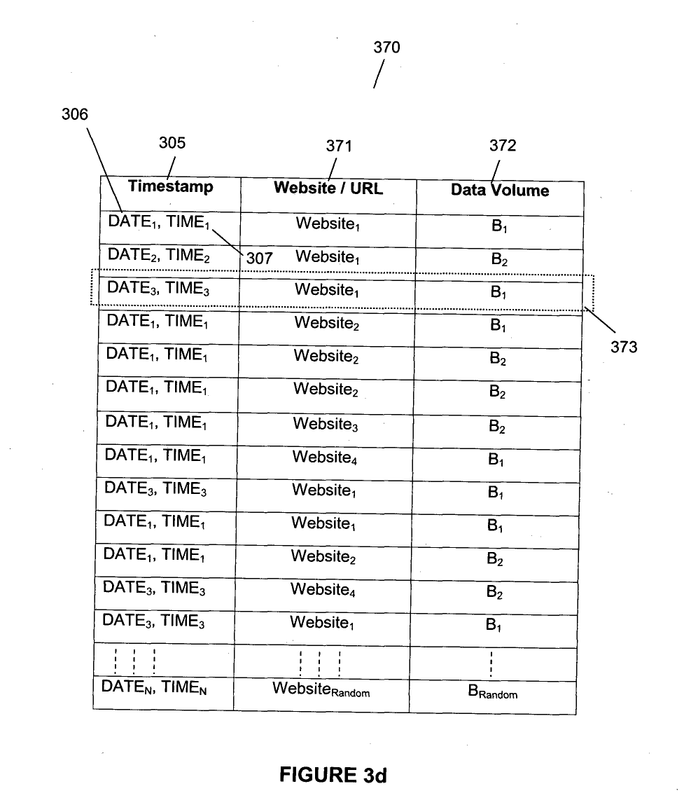

FIG. 3a illustrates an embodiment of the invention whereby entries 300 are illustrated as stored in server 115. Entries 300 comprise raw data that may be transmitted between mobile devices 105, 106 and base station towers 100. One skilled in the art will recognize that although FIG. 1 only illustrates mobile devices 105 and 106, entries 300 may comprise raw data from any number of mobile devices without departing from this invention. These entries 300 may be retrieved and/or processed by server 121 or cloud server 120. Each row of entries 300 corresponds to a unique entry 301, and each entry 301 includes timestamp 305, longitudinal and latitudinal coordinate 310, a record of an entry's data usage 315, a record of an entry's short message service (SMS) usage 320, and/or a record of an entry's voice usage 325. One skilled in the art will recognize that other parameters that may be obtained from the raw data transmitted between mobile devices and base station towers may be included in entry 301 without departing from this invention.

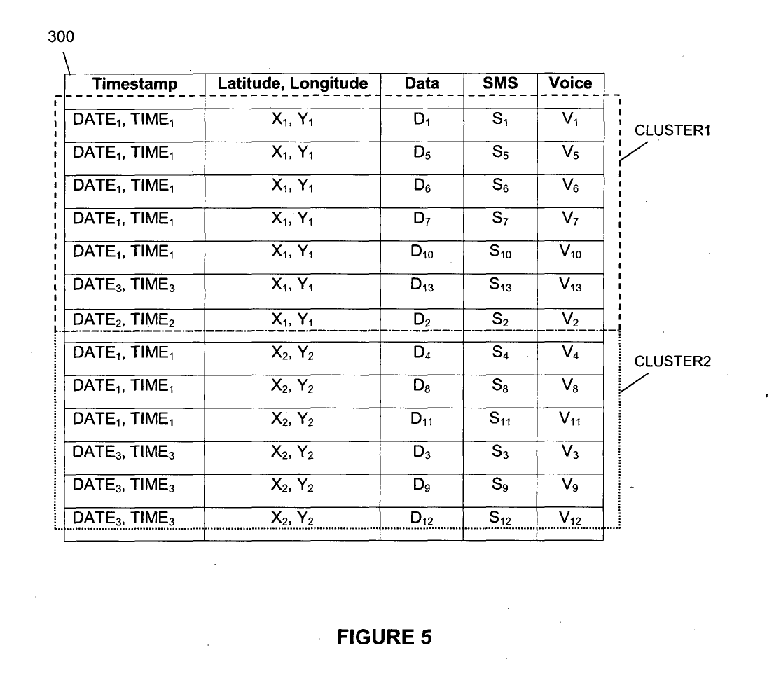

These parameters include, but are not limited to: a user's mobile phone number, a user's country-code, information about a user's mobile phone device, a user's mobile subscription type (prepaid/post-paid), the web-surfing history of a user's mobile device or the URLs (Uniform Resource Locator) accessed, a caller's number, the signal strength of the user's mobile device, the remaining power remaining in the user's mobile device and such other information that may be transmitted between the user's mobile device and the base station towers. Timestamp 305 includes date component 306 and time component 307. The illustration shown in FIG. 3a shows entries 300 having N rows of entries. One skilled in the art will recognize that N may comprise of any number, and may depend on the storage capacity of servers 115, 121 or cloud server 120. Further, one skilled in the art will recognize that entries 300 may be arranged or organized in other formats without departing from this invention. Entries 300 will then be subjected to the process of grouping entries into clusters by server 121 and/or cloud server 120 as described below and as illustrated in FIG. 5.

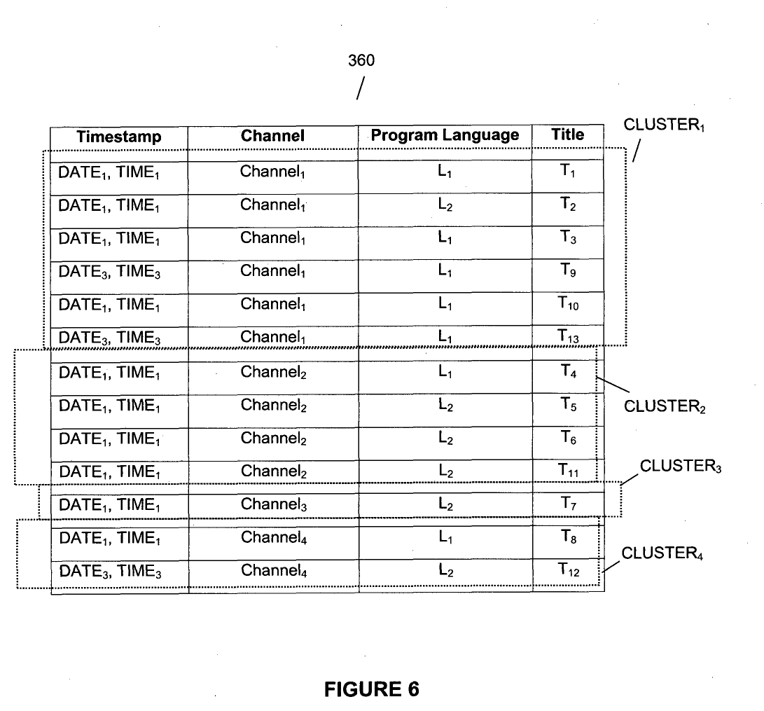

In accordance with other embodiments of the invention, the raw data stored in server 115 may include raw data transmitted between television 107 and modem 111. One skilled in the art will recognize that although FIG. 1 only illustrates television 107, the raw data may be transmitted from any number of televisions or such devices without departing from this invention. FIG. 3c illustrates an embodiment whereby raw data transmitted between television 107 and modem 111 is stored in server 115 as entries 360. Entries 360 may be retrieved and/or processed by server 121 or cloud server 120. Each row of entries 360 corresponds to a unique entry 364, and each entry 364 includes timestamp 305, a record of channel 361, a record of an entry's program language 362 and/or a record of an entry's title 363. One skilled in the art will recognize that other parameters that may be obtained from the raw data transmitted between television 107 and modem 111 may be included in entry 364 without departing from this invention. Similarly, timestamp 305 includes date component 306 and time component 307. The illustration shown in FIG. 3c shows entries 360 having N rows of entries. One skilled in the art will recognize that N may comprise of any number, and may depend on the storage capacity of servers 115, 121 or cloud server 120. Further, one skilled in the art will recognize that entries 360 may be arranged or organized in other formats without departing from this invention. Entries 360 will then be subjected to the process of grouping entries into clusters by server 121 and/or cloud server 120 as described below and as illustrated in FIG. 6.

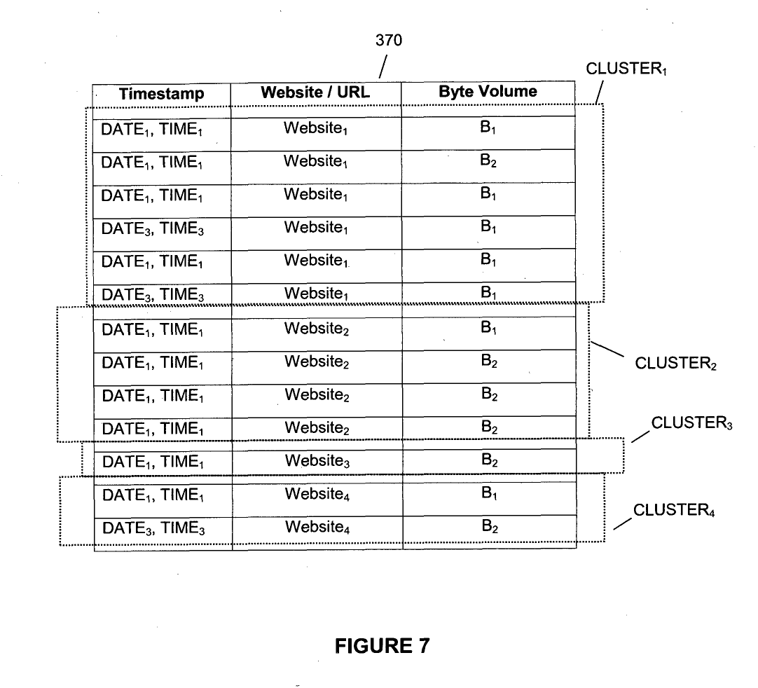

In accordance with other embodiments of the invention, the raw data stored in server 115 may include raw data transmitted between computer 108 and modem 111. One skilled in the art will recognize that although FIG. 1 only illustrates computer 108, the raw data may be transmitted from any number of computers or such devices without departing from this invention. FIG. 3d illustrates an embodiment whereby raw data transmitted between computer 108 and modem 111 is stored in server 115 as entries 370. Entries 370 may be retrieved and/or processed by server 121 or cloud server 120. Each row of entries 370 corresponds to a unique entry 373, and each entry 373 includes timestamp 305, a record of a website/universal resource locator 371 and/or a record of an entry's data volume 372. One skilled in the art will recognize that other parameters that may be obtained from the raw data transmitted between computer 108 and modem 111 may be included in entry 373 without departing from this invention. Again, timestamp 305 includes date component 306 and time component 307. The illustration shown in FIG. 3d shows entries 370 having N rows of entries. One skilled in the art will recognize that N may comprise of any number, and may depend on the storage capacity of servers 115, 121 or cloud server 120. Further, one skilled in the art will recognize that entries 370 may be arranged or organized in other formats without departing from this invention. Entries 370 will then be subjected to the process of grouping entries into clusters by server 121 and/or cloud server 120 as described below and as illustrated in FIG. 7.

In further embodiments of the invention, each of entries 300 as illustrated in FIG. 3a may also be provided with a mobile number belonging to a mobile device to which that particular entry is associated with. Such an embodiment is illustrated in FIG. 3b whereby entry 351 in addition to having the parameters illustrated in FIG. 3a, also includes a record of a mobile device's mobile number, which is mobile number 355.

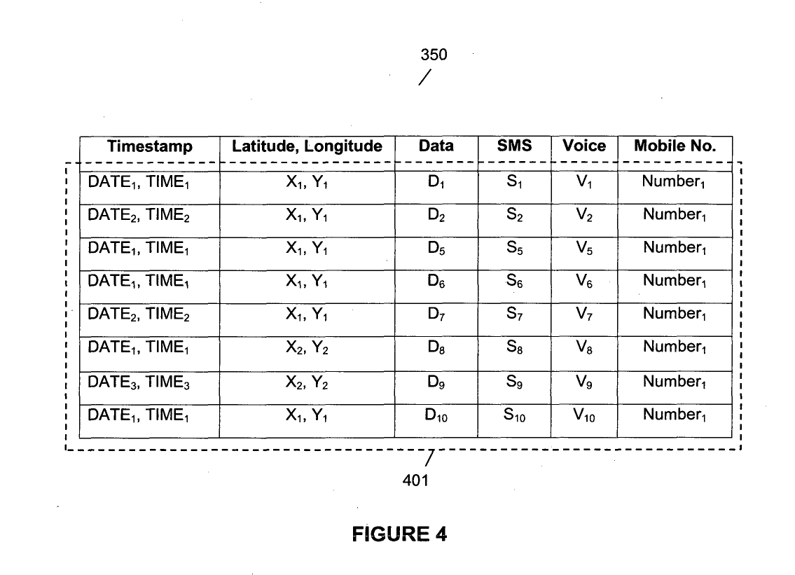

The inclusion of a mobile device's mobile number 355 into each of entries 350 allows the invention to generate activity grid tables associated with a particular user. For example, with reference to FIGS. 3b and 4, if server 121 or cloud server 120 were to generate an activity grid table associated with a first mobile device user having mobile number “Number1”, server 121 and/or cloud server 120 would first segregate each of entries 350 into groups with each group corresponding to a particular mobile number. In this example, the group corresponding to “Number1” would be selected and the other entries belonging to the other groups will then be excluded from entries 350. Such an embodiment is illustrated in FIG. 4 whereby the entries have been segregated according to their mobile numbers and in this illustration; it is shown that only group 360 corresponding to mobile number “Number1” has been selected. In particular, the remaining groups of entries that do not correspond to mobile number “Number1” have been excluded from entries 350. One skilled in the art will recognize that server 121 and/or cloud server 120 may generate activity grid tables associated with other mobile device users by selecting the group of entries that have the corresponding mobile number associated with the mobile device user of interest, e.g. “Number2”, etc. Once the appropriate group has been selected, the entries in this group may then be subjected to the process of grouping entries into clusters by server 121 and/or cloud server 120 as described below and as illustrated in FIG. 5. One skilled in the art will recognize that when an entry is excluded by the system, the entry may be moved to another database, deleted, blacklisted and/or omitted from subsequent processes.

FIG. 5 illustrates an example of grouping entries 300 into clusters, with each cluster corresponding to a range of longitudinal and latitudinal coordinates. As shown in FIG. 5, Cluster1 corresponds to a longitudinal and latitudinal range of X₁,Y₁ while Cluster2 corresponds to a longitudinal and latitudinal range of X₂,Y₂. In other words, entries having longitudinal and latitudinal coordinates that fall within the longitudinal and latitudinal range of Cluster1 will be grouped into Cluster1 while entries having longitudinal and latitudinal coordinates that fall within the longitudinal and latitudinal range of Cluster2 will be grouped into Cluster2.

In other embodiments of the invention, entries 300 may be grouped into a cluster having a broader range of longitudinal and latitudinal coordinates. For example, Cluster3 (not shown) may have a range of longitudinal and latitudinal coordinates between X₁,Y₁ and X₂,Y₂. This would result in a cluster having a greater number of entries as compared to the number of entries in Cluster1 or Cluster2. Such a broader grouping arrangement would be useful for visual representations involving plots on maps.

After entries 300 have been grouped into their respective clusters, one of these clusters may then be selected and each entry within this cluster will then be verified. In the verification process, entries that are verified will be validated while entries that are not verified will be excluded. The type of verification performed by the system on the entries depends on the type of visual representation that is to be generated and displayed by the system. Entries that are validated by the system will be visually represented in the table and/or on a map while entries that are invalidated by the system will be excluded. In embodiments of the invention, excluded entries may be deleted from the cluster, blacklisted by the system or moved out of the cluster into a separate group.

In accordance with another embodiment of the invention, entries 360 may be grouped into clusters, with each cluster corresponding to a particular channel. This embodiment is illustrated in FIG. 6. As shown in FIG. 6, Cluster1 corresponds to Channel₁ while Cluster2 corresponds to Channel₂. In other words, entries having a record of a channel that matches the channel associated with Cluster1 will be grouped into Cluster1 while entries having a record of a channel that matches the channel associated with Cluster2 will be grouped into Cluster2. After entries 360 have been grouped into their respective clusters, one of these clusters may then be selected and each entry within this cluster will then be verified. In the verification process, entries that are verified will be validated while entries that are not verified will be excluded. The type of verification performed by the system on the entries depends on the type of visual representation that is to be generated and displayed by the system. Entries that are validated by the system will be visually represented in a table while entries that are invalidated by the system will be excluded. In embodiments of the invention, excluded entries may be deleted from the cluster, blacklisted by the system or moved out of the cluster into a separate group.

In accordance with yet another embodiment of the invention, entries 370 may be grouped into clusters, with each cluster corresponding to a particular website/universal resource locator. Such an embodiment is illustrated in FIG. 7. As shown in FIG. 7, Cluster1 corresponds to Website₁ while Cluster2 corresponds to Website₂. In other words, entries having a record of a website/universal resource locator that matches the website/universal resource locator associated with Cluster1 will be grouped into Cluster1 while entries having a record of a website/universal resource locator that matches the website/universal resource locator associated with Cluster2 will be grouped into Cluster2. After entries 370 have been grouped into their respective clusters, one of these clusters may then be selected and each entry within this cluster will then be verified. In the verification process, entries that are verified will be validated while entries that are not verified will be excluded. The type of verification performed by the system on the entries depends on the type of visual representation that is to be generated and displayed by the system. Entries that are validated by the system will be visually represented in a table while entries that are invalidated by the system will be excluded. In embodiments of the invention, excluded entries may be deleted from the cluster, blacklisted by the system or moved out of the cluster into a separate group.

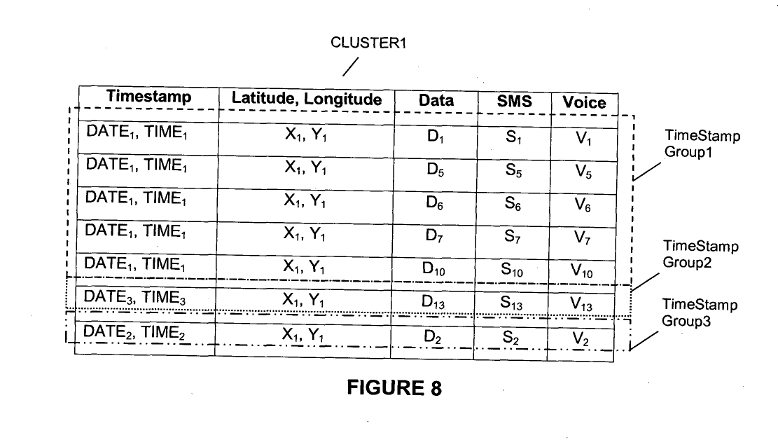

In accordance with an embodiment of the invention, a process for verifying entries in the clusters described above is illustrated in FIG. 8. In this example, entries in a selected cluster are grouped into timestamp groups, with each timestamp group corresponding to a timestamp range. In the example shown in FIG. 8, entries having a timestamp range of Date₁, Time₁ are grouped into TimeStamp Group1 while entries having a timestamp range of Date₃, Time₃ are grouped into TimeStamp Group2 and entries having a timestamp range of Date₂, Timeₜ are grouped into TimeStamp Group3. One skilled in the art will recognize that the range of a timestamp group may vary, that is it may be wider or narrower, and the range of the timestamp group is left as a design choice. Further, one skilled in the art will recognize that the range corresponding to each timestamp groups is left as a design choice and is dependent on the number of entries to be validated.

The system then performs a verification process to determine the validity of a timestamp group whereby timestamp groups having a number of entries less than a minimum number or minimum threshold are excluded while those that pass the verification process will be validated. When this happens, entries within the excluded timestamp group are excluded as well. Timestamp groups that have a number of entries exceeding a minimum number or a minimum threshold will be validated. As a result, the entries in the validated timestamp groups will be validated too. The minimum number or the minimum threshold may comprise any integer and is left as a design choice for one skilled in the art. In the example illustrated in FIG. 8, if the minimum number is set as one, this means that TimeStamp Group2 and TimeStamp Group3 will be excluded as the number of entries in these groups is less than the minimum number. In embodiments of the invention, this minimum number may be dependent on the amount of entries with the minimum number increasing as the amount of entries increases.

In accordance with other embodiments of the invention, entries in a cluster associated with a latitudinal and longitudinal coordinate range having data usage, SMS usage and voice usage records may be verified based on a minimum data usage threshold, a minimum SMS usage threshold and/or a minimum voice usage threshold. In accordance with another embodiment of the invention, entries in a cluster associated with a particular channel having a record of program language and/or title may be verified based on a match between the entry's record of the program language and/or title and a predetermined program language and/or title. In accordance with yet another embodiment of the invention, entries in a cluster associated with a particular website/universal resource locator having a record of data volumes being uploaded to or downloaded from the particular website/universal resource locator may be verified based on a minimum data volume transfer threshold.

In these embodiments, entries that are invalidated will be excluded from the cluster. The validation method applied by the system depends on the visual representation that is to be generated and displayed. As an example, with regard to a cluster associated with a latitudinal and longitudinal range, if the system is to generate a grid table showing the SMS activity of a mobile device's user, the system will choose to validate the entries in the cluster by comparing the appropriate record in the entries with a minimum SMS usage threshold. Similarly, if the system is to generate a grid table showing the data usage activity of a mobile device's user, the system will choose to validate the entries in the cluster by comparing the appropriate record in the entries with a minimum data usage threshold. Further, if the system is to generate a grid table showing the voice usage activity of a mobile device's user, the system will choose to validate the entries in the cluster by comparing the appropriate record in the entries with a minimum voice usage threshold. The minimum number or minimum threshold used in these embodiments may comprise any integer and is left as a design choice for one skilled in the art. As an example, the thresholds may be determined according to the statistical distribution of the voice/SMS/data event per usage (usage is here the number of “hits” or distinct event transactions), with the aim of discarding outlier or irrelevant data entries.

As another example, with regard to a cluster associated with a record of a particular channel, if the system is to generate a grid table showing the language of a program watched by a user, the system will choose to validate the entries in the cluster by comparing the appropriate record in the entries with a language of interest. Similarly, if the system is to generate a grid table showing the title of the program watched by a user, the system will choose to validate the entries in the cluster by comparing the appropriate record in the entries with a title of a program that is of interest. The program language of interest and the title of the program used in these embodiments may comprise any alphanumeric entry and is left as a design choice for one skilled in the art. For example, the program language of interest may be English while the title may be “Computers101”.

As yet another example, with regard to a cluster associated with a record of a particular website/universal resource locator, if the system is to generate a grid table showing the volume of data uploaded to the website or downloaded from the website by the user, the system will choose to validate the entries in the cluster by comparing the appropriate record in the entries with a minimum threshold of data volume uploaded or downloaded. The minimum threshold of data volume uploaded or downloaded used in these embodiments may comprise any integer and is left as a design choice for one skilled in the art. For example, the minimum threshold of data volume may be 1 Megabytes or 100 kilobytes whereby any entries having data volumes below this threshold is to be excluded.

In accordance with embodiments of the invention, an empty grid table may generated by the system prior to the retrieving of the entries from server 115. One skilled in the art will recognize that the empty grid table may also be generated by the system at any time throughout the process as long as the table is generated prior to the table marking process.

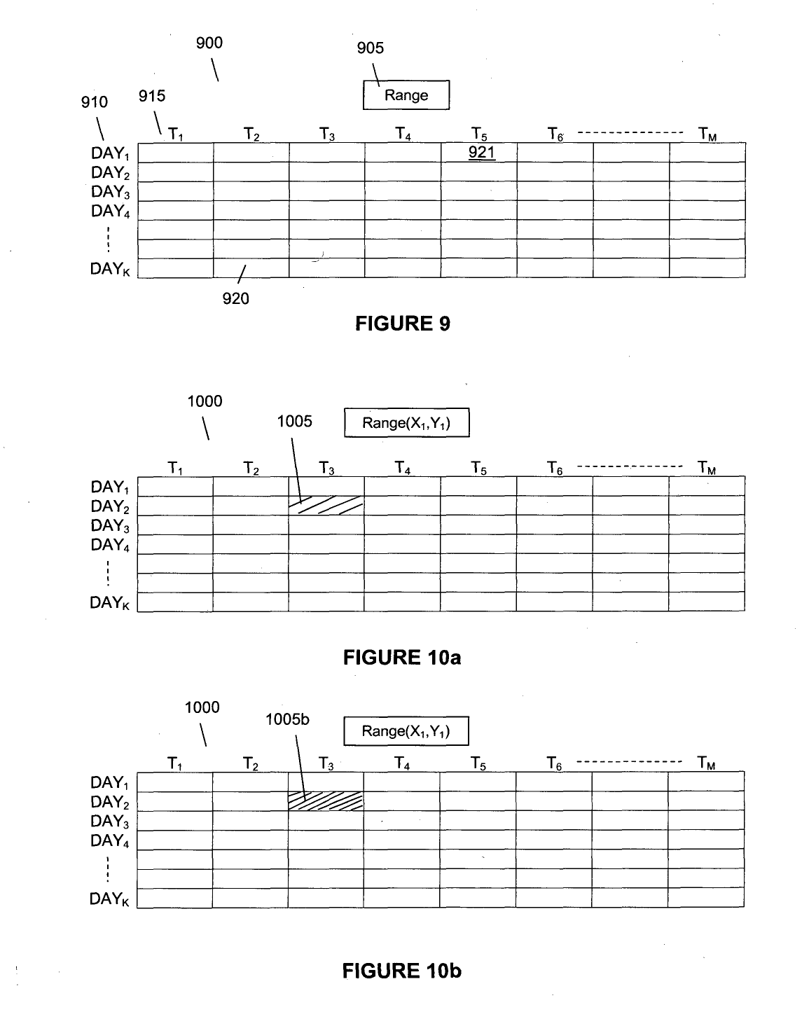

FIG. 9 illustrates such a table, which is table 900 having columns 915 and rows 910. In this illustration, table 900 is shown having range 905 as table 900 was generated to be linked to a cluster having a latitudinal and longitudinal range 905. The linking of table 900 to a cluster is described in detail below. Range 905 may be displayed by the system or may be hidden from view. Empty grid tables may be generated to be linked to clusters associated with other parameters as well and such embodiments will be described below.

Columns 915 in table 900 correspond to a time component. The time component may be displayed in the format of M hours, minutes, seconds or combinations thereof. Rows 910 correspond to a date component. The date component may be displayed in the format of K days of the week or dates. For example, if K were to be chosen as 5, this would mean that any 5 days of the week may be used as rows 910. In embodiments of the invention, columns 915 and rows 910 form grids 920 on table 900. Each grid of grids 920 correspond to specific timeslots on table 900. For example, as shown in FIG. 9, grid 921 corresponds to Day1 at time T5. If Day1 were to represent Sunday and T5 were to represent 0500 hours, this would mean that grid 921 corresponds to a timeslot of 0500 hours on a Sunday on table 900.

In accordance with embodiments of the invention, after the entries in the selected cluster associated with a latitudinal and longitudinal range have been validated, the system will link table 900 to the selected cluster. For example, with reference to FIG. 5, table 900 may be linked to either Cluster1 or Cluster2. This linking step grants table 900 access to the validated entries contained in the linked cluster and also causes table 900 to adopt the same latitudinal and longitudinal range of the linked cluster.

After the validated entries in the cluster are linked to the table, the system marks timeslots or grids on table 900 that correspond to the timestamps of the validated entries. FIG. 10a illustrates table 1000 that is linked to a cluster having a longitudinal and latitudinal range of X₁,Y₁. With reference to the example described above that references FIG. 8, as only the entries in TimeStamp Group1 have been validated, only the timestamps of these entries will be marked out on the grids of table 1000. In the example, assuming that Date₁, Time₁ corresponds to Day₂, T₃, that is grid 1005, this results in a mark being applied to grid 1005. As there are five entries having timestamps corresponding to grid 1005, this results in more marks being applied to grid 1005. The additional marking of grid 1005 is illustrated at grid 1005b in FIG. 10b. This graduated tone marking methodology allows the system to process and display large amounts of raw data without losing granularity.

In accordance with embodiments of the invention, the marking of a grid on the table comprises graduated tone marking methodologies. An example of such a methodology would be a marking methodology that utilizes a colorimetric model. In the colorimetric model, the system determines a suitable colour range that is to be applied and this range is based on the number of validated entries. Under this approach, instead of markings that utilize hatches or crosses, the grid to be marked is coloured In other words; the number of markings on a grid can be shown by varying the tone of the colour applied to the grid. A lighter coloured grid represents lesser markings while a darker coloured grid represents an increased number of markings. This marking methodology also allows the system to process and display large amounts of raw data without losing granularity. One skilled in the art will recognize that other types or forms of graduated tone marking methodologies may be employed to mark the grids of the table without departing from this invention.

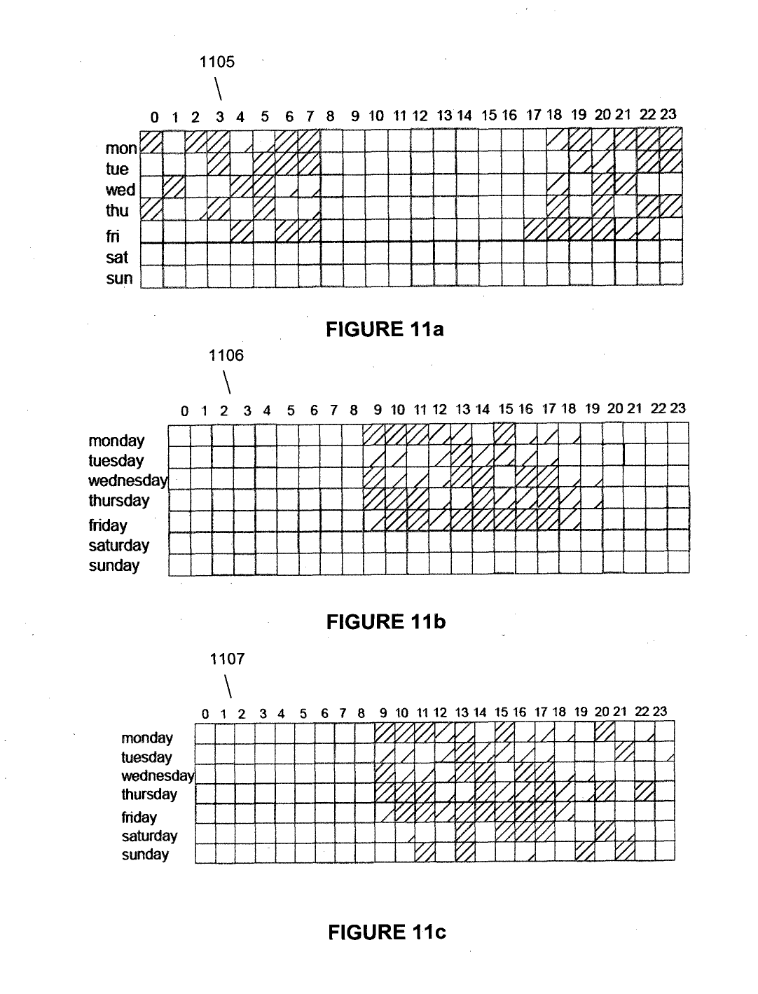

FIGS. 11a, 11b and 11c illustrate some examples of tables that have been marked in accordance with embodiments of this invention. Table 1105 in FIG. 11a illustrates the timings at which a mobile device's user spends at a particular longitudinal and latitudinal range. In generating table 1105, the system used a validation process whereby timestamp groups having a number of entries less than a minimum number or minimum threshold were excluded. The timestamps of the validated entries were then marked on the corresponding timeslots or grids of table 1105.

Table 1106 in FIG. 11b illustrates the timings at which a mobile device's user spends talking on the mobile device based upon the record of voice usage of the mobile device, at a particular longitudinal and latitudinal range. In generating table 1106, the system used a validation process whereby entries in a cluster exceeding a minimum data usage threshold are validated. The timestamps of the validated entries were marked on the corresponding timeslots or grids of table 1106.

Table 1107 in FIG. 11c illustrates the timings at which a mobile device's user spends sending SMSs using the mobile device, which is based on the record of SMS usage of the mobile device, at a particular longitudinal and latitudinal range. In generating table 1107, the system used a validation process whereby entries in a cluster exceeding a minimum SMS usage threshold are validated. The timestamps of the validated entries were marked on the corresponding timeslots or grids of table 1107.

In these examples, one skilled in the art will recognize that grids having more hatched markings represent a greater number of entries having timestamps that correspond to that particular grid or timeslot as compared to grids having lesser hatched markings. With reference to table 1105, table 1105 shows that the user of the mobile device is not present at that particular longitudinal and latitudinal range between 0800 hours to 1700 hours between Monday and Friday and is not present at that particular longitudinal and latitudinal range for the whole of Saturday and Sunday.

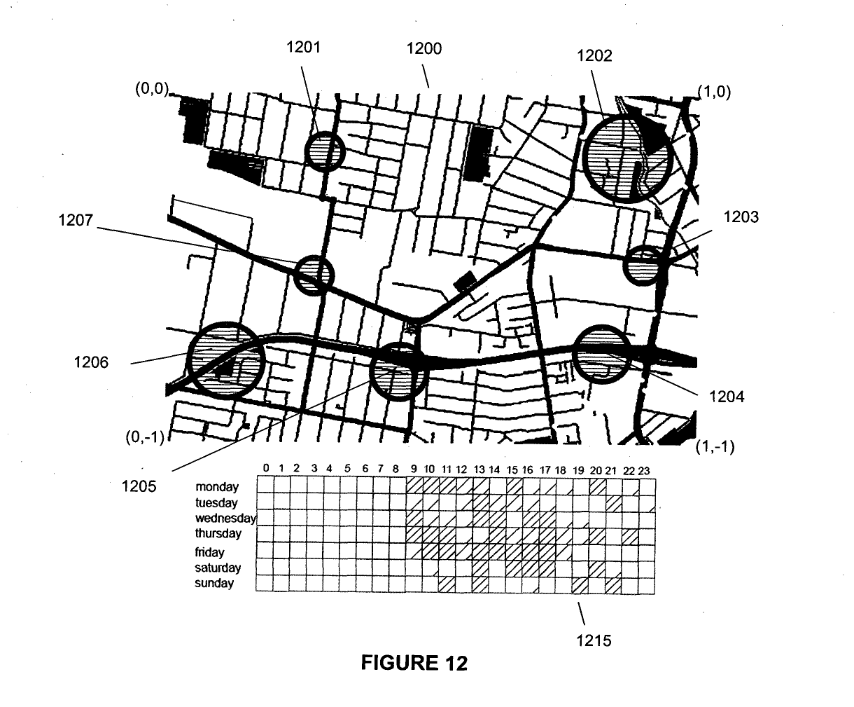

In accordance with embodiments of the invention, the system may generate and display a map to visually represent the geographical locations that correspond to certain events. Such an example is illustrated in FIG. 12. FIG. 12 illustrates map 1200. Map 1200 corresponds to the longitudinal and latitudinal range of table 1107. In other words, in this example, the longitudinal and latitudinal range associated with table 1107 comprises the area bounded by coordinates (0,0), (0,−1), (1,−1) and (1,0) on map 1200. The system then plots the longitudinal and latitudinal coordinates of the validated entries on map 1200. This results in plots 1201-1207. The plotting of map 1200 may comprise graduated tone plotting, graphing schemes such as colorimetric marking schemes.

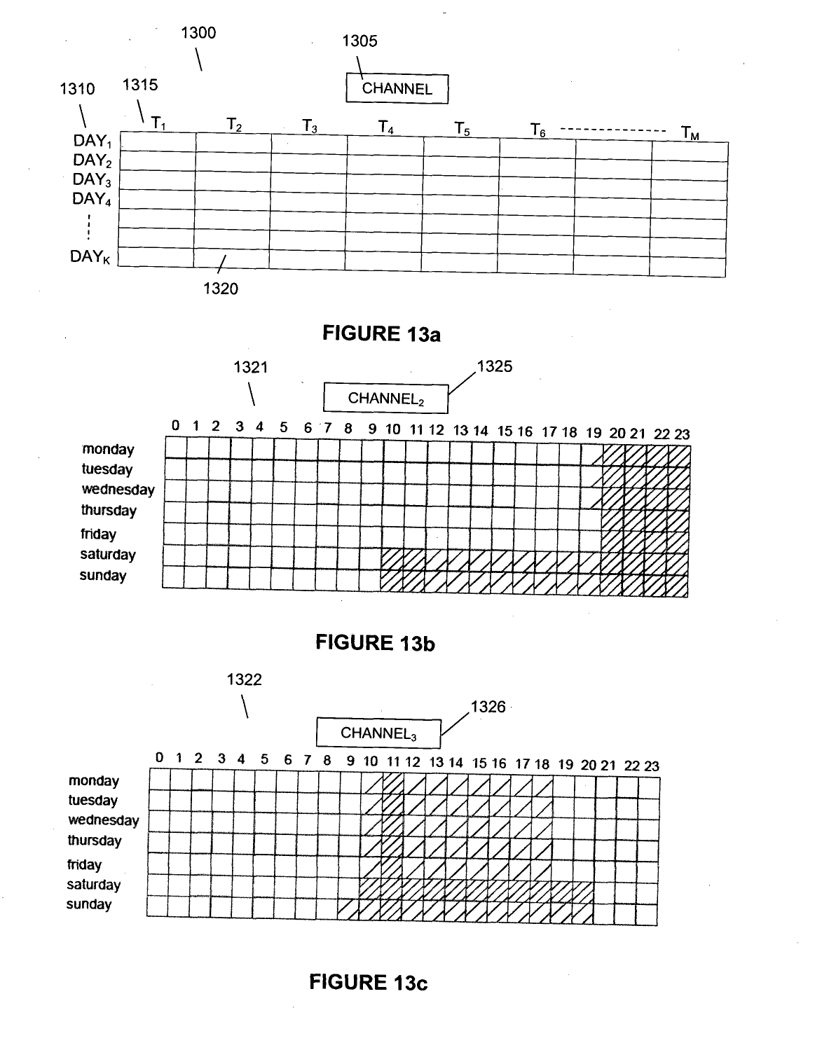

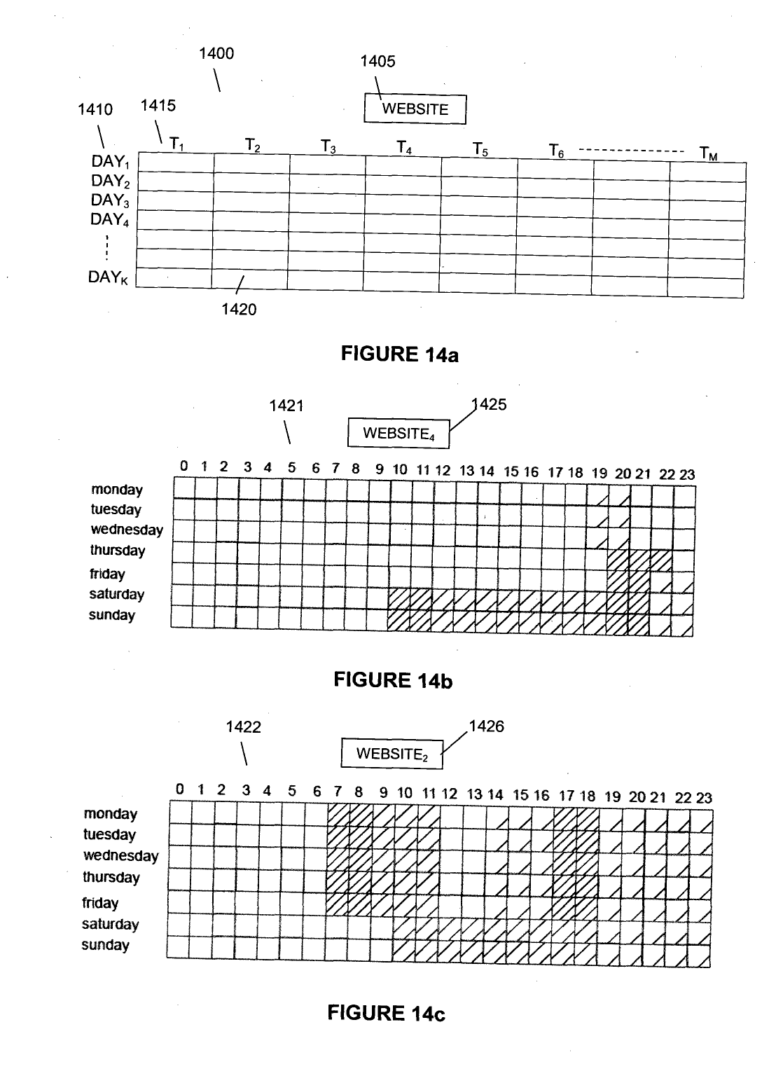

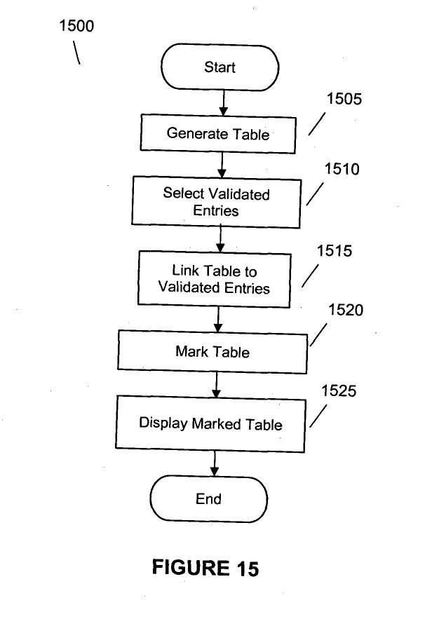

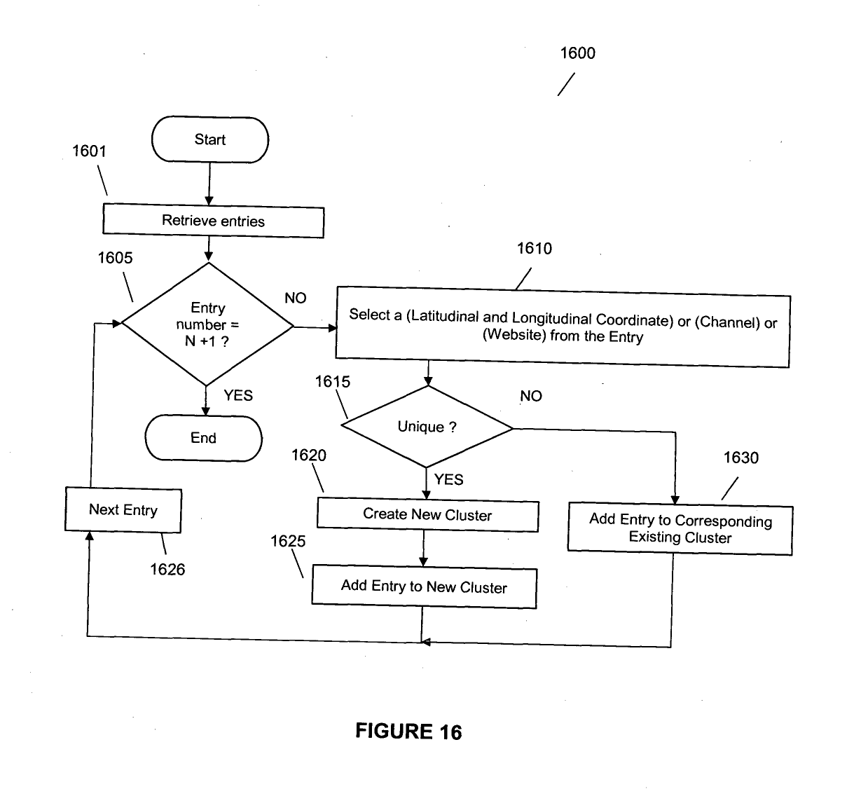

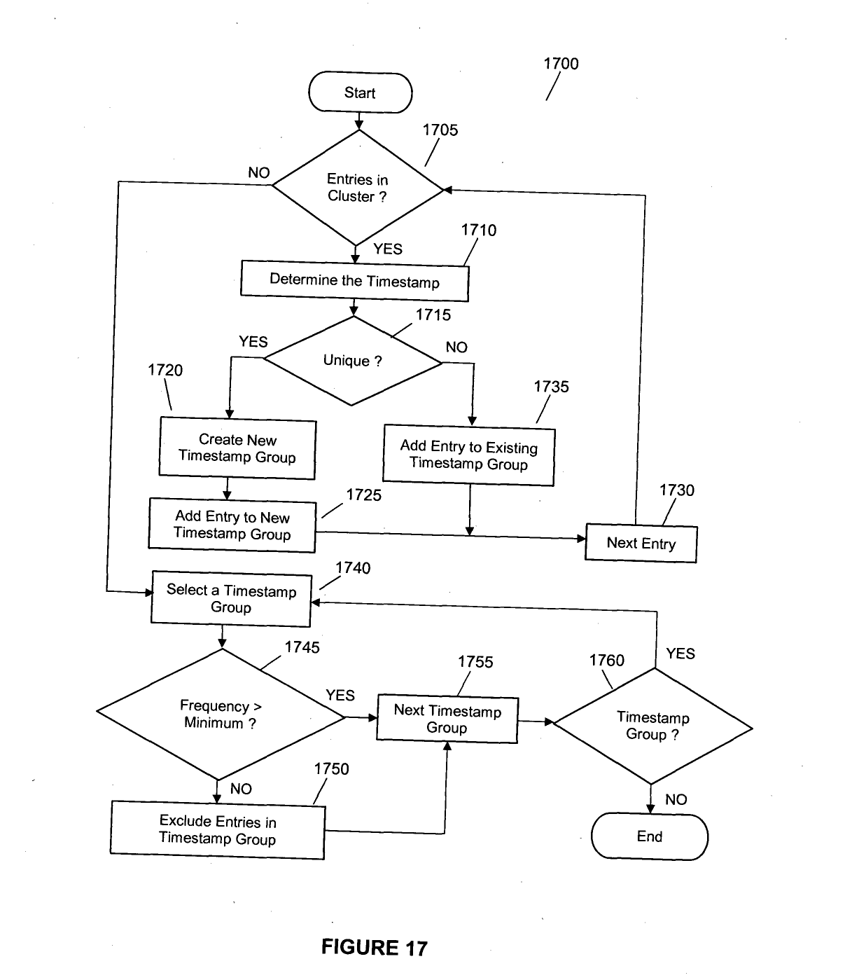

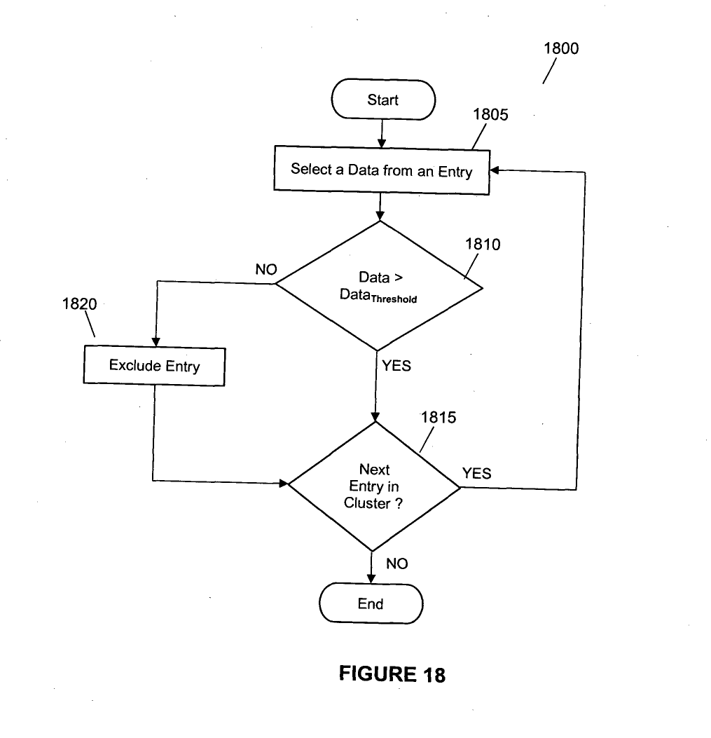

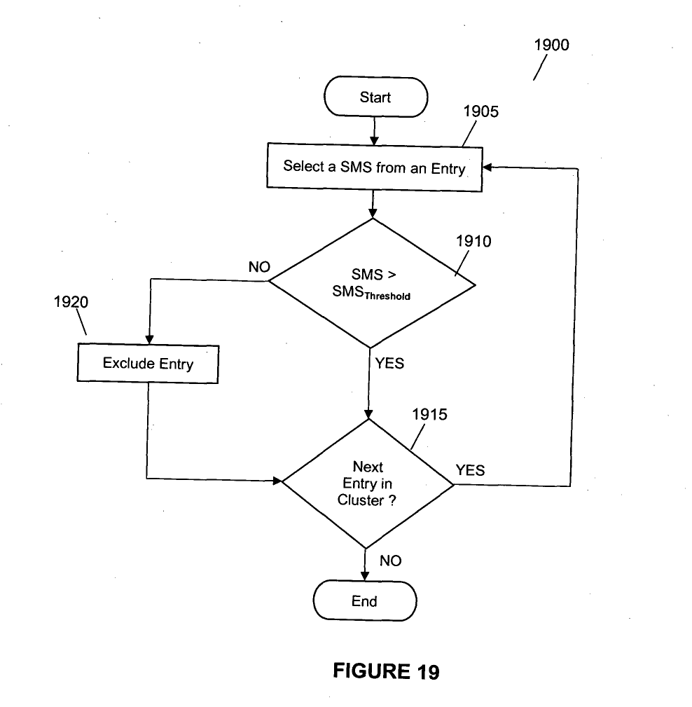

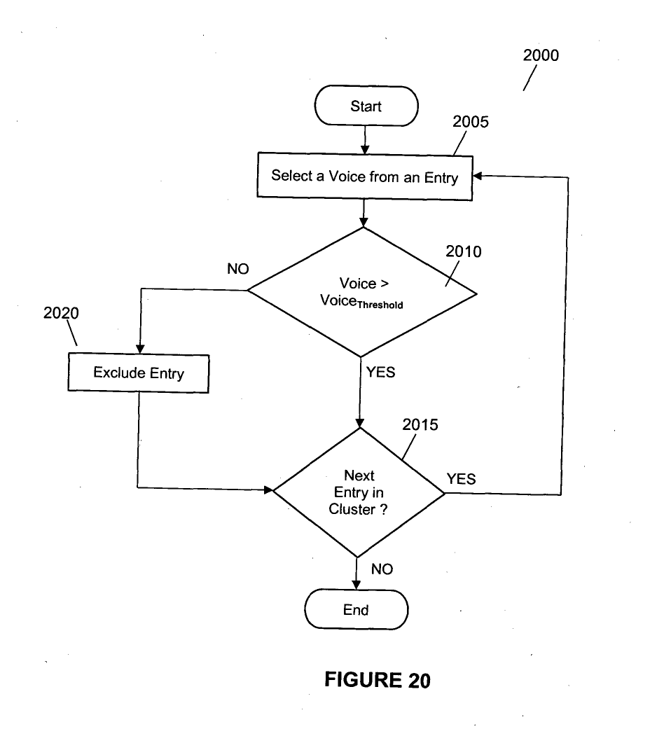

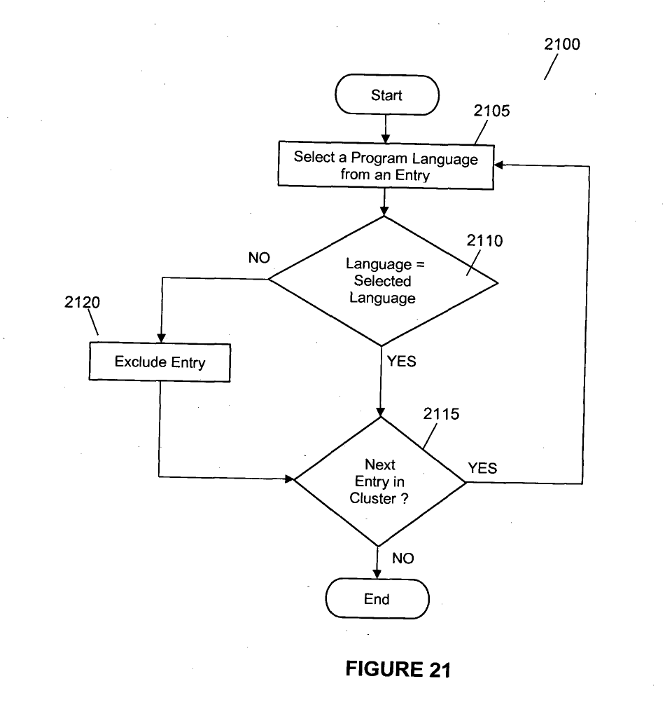

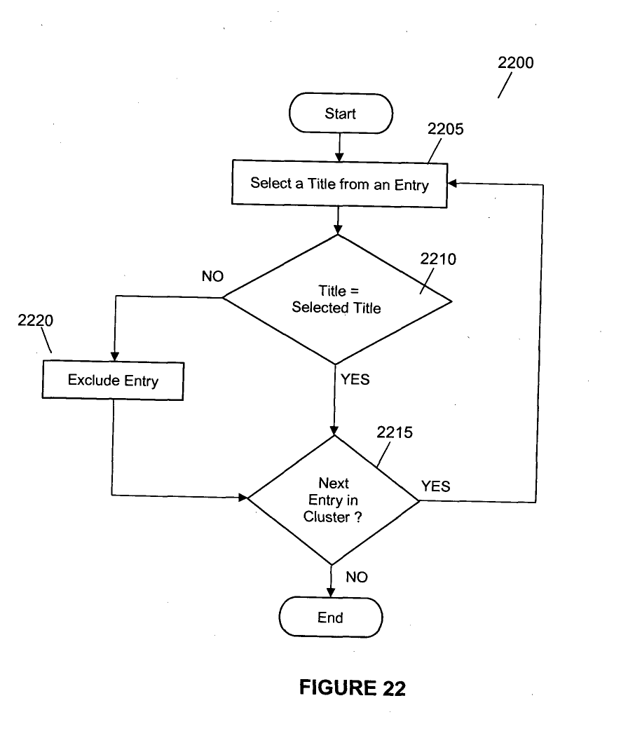

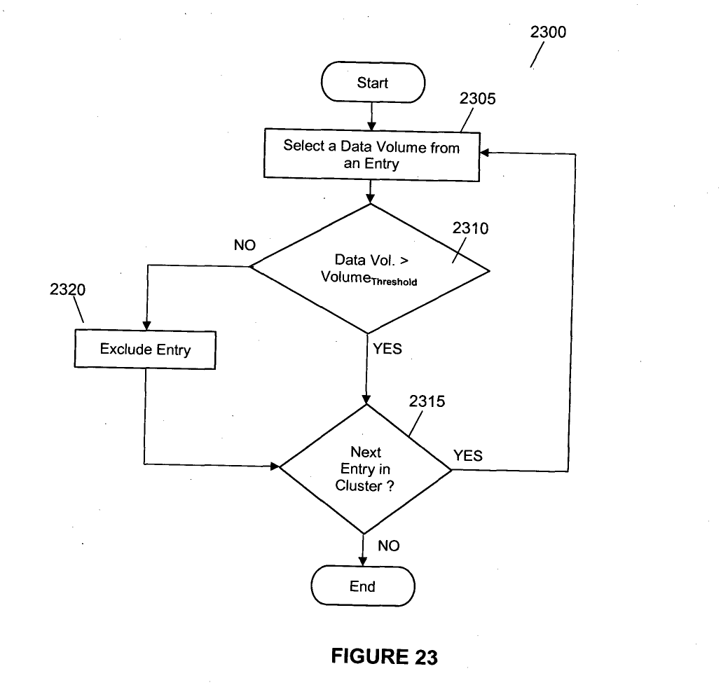

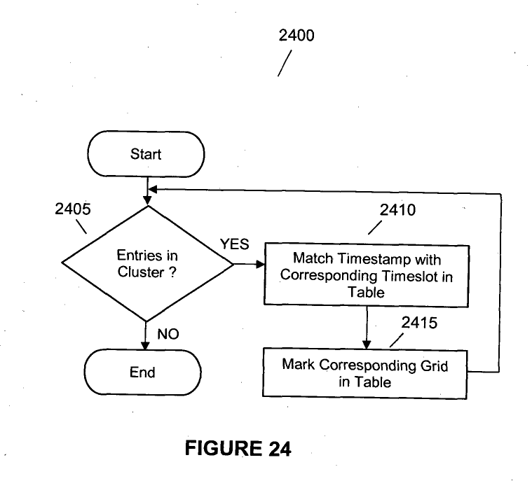

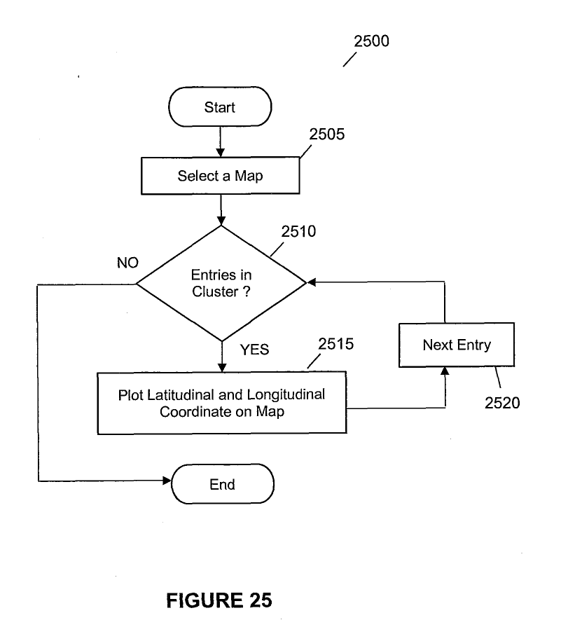

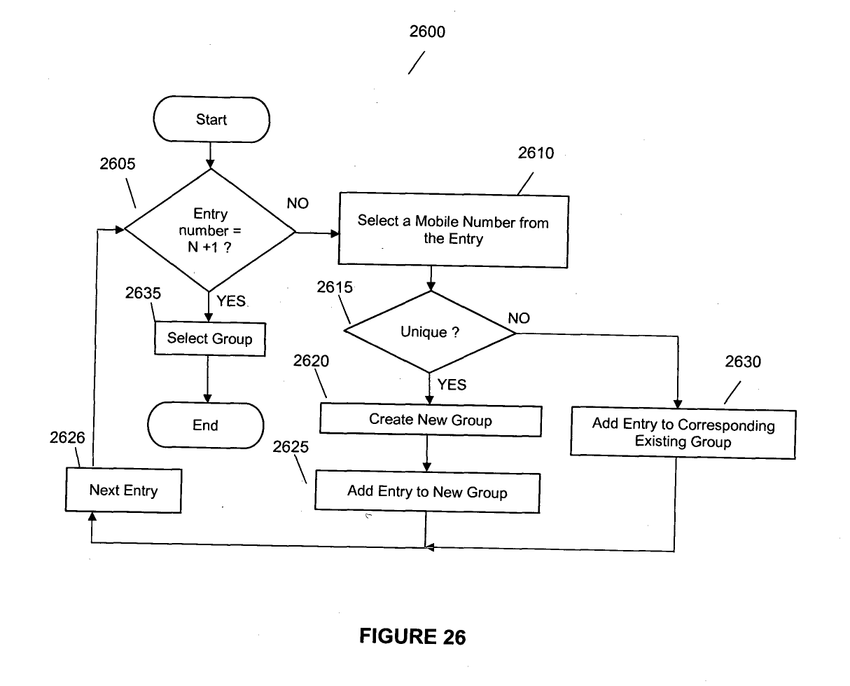

FIG. 13a illustrates another embodiment of the invention whereby table 1300 has channel 1305 as a header as table 1300 was generated to be linked to a cluster associated with a channel. Similarly, columns 1315 in table 1300 correspond to a time component. The time component may be displayed in the format of M hours, minutes, seconds or combinations thereof. Rows 1310 correspond to a date component. The date component may be displayed in the format of K days of the week or dates. For example, if K were to be chosen as 5, this would mean that any 5 days of the week may be used as rows 1310. In embodiments of the invention, columns 1315 and rows 1310 form grids 1320 on table 1300. As mentioned above, each grid of grids 1320 correspond to specific timeslots on table 1300.

In accordance with embodiments of the invention, after the entries in the selected cluster associated with a particular channel have been validated, the system will link table 1300 to the selected cluster. For example, with reference to FIG. 6, table 1300 may be linked to Cluster1, Cluster2, Cluster3 or Cluster4. This linking step grants table 1300 access to the validated entries contained in the linked cluster and also causes channel 1305 of table 1300 to adopt the same channel as the linked cluster.

After the validated entries in the cluster are linked to the table, the system marks timeslots or grids on table 1300 that correspond to timestamps of the validated entries. As an example, FIG. 13b illustrates table 1321 that is linked to a cluster having an associated channel Channel₁. Table 1321 is marked using the graduated tone marking methodology as this allows the system to process and display large amounts of raw data without losing granularity. FIGS. 13b and 13c illustrate some examples of tables that have been marked in accordance with embodiments of this invention. Table 1321 in FIG. 13b illustrates the timings at which a user spends watching Channel₂ while table 1322 in FIG. 13c illustrates the timings at which a user spends watching Channel₃.

In accordance with another embodiment of the invention, table 1400 having columns 1415 and rows 1410 may be generated. As illustrated in FIG. 14a, table 1400 is shown having website 1405 as table 1400 was generated to be linked to a cluster associated with a website. Similarly, columns 1415 in table 1400 correspond to a time component. The time component may be displayed in the format of M hours, minutes, seconds or combinations thereof. Rows 1410 correspond to a date component. The date component may be displayed in the format of K days of the week or dates. For example, if K were to be chosen as 5, this would mean that any 5 days of the week may be used as rows 1410. In embodiments of the invention, columns 1415 and rows 1410 form grids 1420 on table 1400. As mentioned above, each grid of grids 1420 correspond to specific timeslots on table 1400.

In accordance with embodiments of the invention, after the entries in the selected cluster associated with a particular website have been validated, the system will link table 1400 to the selected cluster. For example, with reference to FIG. 7, table 1400 may be linked to Cluster1, Cluster2, Cluster3 or Cluster4. This linking step grants table 1400 access to the validated entries contained in the linked cluster and also causes channel 1405 of table 1400 to adopt the same channel as the linked cluster.

After the validated entries in the cluster are linked to the table, the system marks timeslots or grids on table 1400 that correspond to the timestamps of the validated entries. FIG. 14b illustrates table 1421 that is linked to a cluster having an associated website Website₄. Table 1421 is marked using the graduated tone marking methodology as this allows the system to process and display large amounts of raw data without losing granularity. FIGS. 14b and 14c illustrate some examples of tables that have been marked in accordance with embodiments of this invention. Table 1421 in FIG. 14b illustrates the timings at which a user spends at Website₄ while table 1422 in FIG. 14c illustrates the timings at which a user spends watching Website₂.

In order to provide such a system, a user activity grid table generation process is needed that can retrieve entries from a server and based on a series of processes applied to these retrieved entries, generate and display a marked table. The following description and FIGS. 15-26 describe embodiments of processes that provide such a generation process in accordance with this invention.

FIG. 15 illustrates process 1500 that is performed by a computer system in a server to generate a user activity grid table in accordance with embodiments of this invention. Process 1500 begins in step 1505 by generating a table having a plurality of grids. Such a table has been previously illustrated in FIG. 9. Each of the grids in this table represents a particular timeslot as the y-axis of the table corresponds to a date or day of a week while the x-axis of the table corresponds to an hour in a day. The number of rows and columns of the table are left as design choices to one skilled in the art. Process 1500 then selects validated entries for further processing at step 1510. The process for selecting validated entries is described in greater detail below with reference to FIGS. 16-23. The validated entries are then linked to the table at step 1515. This linking step grants the table access to these validated entries. The table is then marked at step 1520 and the marked table is displayed at 1525. Process 1500 marks grids in the table that correspond with the timestamps of the validated entries. The process for marking the grid in accordance with some embodiments of this invention is described below with reference to FIG. 24. Process 1500 then ends.

FIG. 16 illustrates process 1600 that is performed by a computer system in a server to retrieve and group the retrieved entries into clusters in accordance with some embodiments of this invention prior to the entries in a selected cluster undergoing verification and validation processes. Process 1600 begins in step 1601 by retrieving N entries from a server. N is an integer that represents the number of entries that is to be retrieved. Each of the entries retrieved from the server includes a timestamp associated with the entry and various other parameters. This retrieved plurality of entries may be similar to the entries illustrated in FIG. 3a, 3b, 3c or 3d. Process 1600 then proceeds to sequentially select an entry from the retrieved plurality of entries at step 1605. In this step, process 1600 checks whether the selected entry is the last entry. If this entry is not the last entry, process 1600 progresses to step 1610.

In step 1610, depending on the type of entries that were retrieved, process 1600 obtains the latitudinal and longitudinal coordinate, the record of the channel or the record of the website/universal resource locator associated with the selected entry. The obtained latitudinal and longitudinal coordinate, record of the channel or record of the website/universal resource locator is compared in step 1615 with an appropriate parameter associated with existing clusters to determine if the obtained latitudinal and longitudinal coordinate, record of the channel or record of the website/universal resource locator falls within the range or matches with parameters associated with existing clusters. If the obtained latitudinal and longitudinal coordinate, record of the channel or record of the website/universal resource locator does not fall within the range or matches with parameters associated with existing clusters, the obtained latitudinal and longitudinal coordinate, record of the channel or record of the website/universal resource locator is deemed to be unique.

When this occurs, process 1600 creates a new cluster in step 1620. The entry from which the latitudinal and longitudinal coordinate, record of the channel or record of the website/universal resource locator was obtained from is then grouped into the newly created cluster in step 1625. Process 1600 then sequentially selects the next entry in step 1626.

Alternatively, if the obtained latitudinal and longitudinal coordinate, record of the channel or record of the website/universal resource locator falls within the range or matches with parameters associated with existing clusters, the obtained latitudinal and longitudinal coordinate, record of the channel or record of the website/universal resource locator is deemed to be not unique. The entry from which the latitudinal and longitudinal coordinate, record of the channel or record of the website/universal resource locator was obtained from is then grouped into the existing cluster in step 1630. Process 1600 then sequentially selects the next entry in step 1626.

Process 1600 repeats steps 1605-1626 until all the entries have been grouped into clusters. Once all the entries have been grouped, process 1600 ends. The range or parameters associated with existing clusters is left as a design choice to one skilled in the art. For example, if each entry in the retrieved plurality of entries includes a latitudinal and longitudinal coordinate, the range associated with the existing cluster at step 1615 would comprise a particular range of latitudinal and longitudinal coordinates. Similarly, if each entry in the retrieved plurality of entries includes a record of a channel or website, the parameter associated with the existing cluster at step 1615 would comprise a particular channel or website accordingly.

Before proceeding to process 1700 in FIG. 7, the system will first select a cluster from the plurality of grouped clusters. The system will then proceed to process 1700. FIG. 17 illustrates process 1700 performed by a computer system in a server to verify and validate the entries in a selected cluster in accordance with some embodiments of this invention. Process 1700 begins in step 1705 by sequentially selecting an entry from the entries in the selected cluster. A timestamp corresponding to the selected entry is then obtained by process 1700 in step 1710. Process 1700 determines, in step 1715, whether the obtained timestamp matches with a timestamp range of an existing timestamp group. If process 1700 is unable to find a match, the obtained timestamp is deemed to be unique and process 1700 then proceeds to step 1720. A new timestamp group is created in step 1720 and the entry related to the obtained timestamp is added to the new timestamp group in step 1725. Process 1700 then progresses to step 1730 where process 1700 selects the next entry from the entries in the selected cluster.

Alternatively, if process 1700 is able to find a match in step 1715, the obtained timestamp is deemed to be not unique and process 1700 then proceeds to step 1735. At this step, the entry related to the obtained timestamp is added to the existing timestamp group with which a match was found. Process 1700 then progresses to step 1730 where similarly, process 1700 sequentially selects the next entry from the entries in the selected cluster.

Process 1700 repeats steps 1705-1230 until all the entries have been grouped into their respective timestamp groups. Once all the entries have been grouped, process 1700 progresses to step 1740. The timestamp range of the timestamp groups is left as a design choice to one skilled in the art.

Process 1700 selects a timestamp group in step 1740. The number of entries in the selected timestamp group is summed and compared to a minimum number of entries in step 1745. If the number of entries in the selected timestamp group exceeds the minimum number of entries, process 1700 progresses to step 1755 where process 1700 selects the next timestamp group. Alternatively, if the number of entries in the selected timestamp groups does not exceed the minimum number of entries, process 1700 moves to step 1750 whereby process 1700 excludes all the entries in this selected timestamp group. When an entry is excluded, the entry may be deleted, removed or treated as blacklisted by the system. Process 1700 then progresses to step 1755 where similarly, process 1700 proceeds to select the next timestamp group. At step 1760, if it is determined that another timestamp group has been selected, process 1700 then repeats from step 1740 to step 1760 until all the timestamp groups have undergone the comparison step in step 1745. The minimum number of entries used in step 1745 is left as a design choice to one skilled in the art.

Another embodiment of the invention for verifying and validating entries in a selected cluster is illustrated in FIG. 18. Process 1800 is performed by a computer system in a server to verify and validate the entries in a selected cluster. The validation process carried out by process 1800 allows for the generation of a user activity grid table that shows the timings that a mobile device user spends transmitting and receiving cellular data in a particular longitudinal and latitudinal range. Process 1800 begins in step 1805 by selecting an entry and by obtaining the data usage record of that entry from the entries in the selected cluster. The obtained data usage record is compared with a data threshold in step 1810. If process 1800 determines that the obtained data usage record exceeds the data threshold, process 1800 progresses to step 1815.

Alternatively, if process 1800 determines that the obtained data usage record does not exceed the data threshold, process 1800 moves to step 1820. In step 1820, the selected entry is excluded from the selected cluster. Once the entry has been compared with the threshold, process 1800 then progresses to step 1815. At step 1815, process 1800 checks if there is another entry in the cluster. If there is another entry, process 1800 repeats from step 1805 to step 1815 until all the entries in the linked cluster have been validated. Alternatively, is there are no further entries, process 1800 ends. The data threshold used at step 1810 is left as a design choice to one skilled in the art.

Another embodiment of the invention for verifying and validating entries in a selected cluster is illustrated in FIG. 19. Process 1900 is performed by a computer system in a server to validate the entries in a selected cluster. The validation process carried out by process 1900 allows for the generation of a user activity grid table that shows the timings that a mobile device user spends transmitting and receiving SMSs in a particular longitudinal and latitudinal range. Process 1900 begins in step 1905 by selecting an entry and by obtaining the SMS usage record of that entry from the entries in the selected cluster. The obtained SMS usage record is compared with a SMS threshold in step 1910. If process 1900 determines that the obtained SMS usage record exceeds the SMS threshold, process 1900 progresses to step 1915. Alternatively, if process 1900 determines that the obtained SMS usage record does not exceed the SMS threshold, process 1900 moves to step 1920. In step 1920, the selected entry is excluded from the selected cluster. Once this is done, process 1900 then progresses to step 1915. In step 1915, process 1900 checks if there is another entry in the cluster. If there is another entry, process 1900 repeats from step 1905 to step 1915 until all the entries in the selected cluster have been validated. Alternatively, if there are no further entries, process 1900 ends. The SMS threshold used at step 1910 is left as a design choice to one skilled in the art.

Yet another embodiment of the invention for verifying and validating entries in a selected cluster is illustrated in FIG. 20. Process 2000 is performed by a computer system in a server to validate the entries in a selected cluster. The validation process carried out by process 2000 allows for the generation of a user activity grid table that shows the timings that a mobile device user spends talking on the mobile device in a particular longitudinal and latitudinal range. Process 2000 begins at step 2005 by selecting an entry and by obtaining the voice usage record of that entry from the entries in the selected cluster. The obtained voice usage record is then compared with a voice threshold at step 2010. If process 2000 determines that the obtained voice usage record exceeds the voice threshold, process 2000 progresses to step 2015.

Alternatively, if process 2000 determines that the obtained voice usage record does not exceed the voice threshold, process 2000 moves to step 2020. In step 2020, the selected entry is excluded from the selected cluster. Once this is done, process 2000 then progresses to step 2015. In step 2015, process 2000 checks if there is another entry in the cluster. If there is another entry, process 2000 repeats from step 2005 to step 2015 until all the entries in the selected cluster have been validated. Alternatively, if there are no further entries, process 2000 ends. The voice threshold used at step 2000 is left as a design choice to one skilled in the art.

Still yet another embodiment of the invention for verifying and validating entries in a selected cluster is illustrated in FIG. 21. Process 2100 is performed by a computer system in a server to validate the entries in a selected cluster. The validation process carried out by process 2100 allows for the generation of a user activity grid table that shows the timings at which a user spends watching a program of a particular language on a particular television channel. Process 2100 begins at step 2105 by selecting an entry and by obtaining the record of the program language of that entry from the entries in the selected cluster. The obtained record of the program language is then compared with a preselected language at step 2110. If process 2100 determines that the obtained record of the program language matches the preselected language, process 2100 progresses to step 2115.

Alternatively, if process 2100 determines that the obtained record of the program language does not match the preselected language, process 2100 moves to step 2120. In step 2120, the selected entry is excluded from the selected cluster. Once this is done, process 2100 then progresses to step 2115. In step 2115, process 2100 checks if there is another entry in the cluster. If there is another entry, process 2100 repeats from step 2105 to step 2115 until all the entries in the selected cluster have been validated. Alternatively, if there are no further entries, process 2100 ends. The preselected language used at step 2100 is left as a design choice to one skilled in the art.

Another embodiment of the invention for verifying and validating entries in a selected cluster is illustrated in FIG. 22. Process. 2200 is performed by a computer system in a server to validate the entries in a selected cluster. The validation process carried out by process 2200 allows for the generation of a user activity grid table that shows the timings at which a user spends watching a particular program based on the title of the program on a particular television channel. Process 2200 begins at step 2205 by selecting an entry and by obtaining the record of the program title of that entry from the entries in the selected cluster. The obtained record of the program title is then compared with a preselected program title at step 2210. If process 2200 determines that the obtained record of the program title matches the preselected program title, process 2200 progresses to step 2215.

Alternatively, if process 2200 determines that the obtained record of the program title does not match the preselected program title, process 2200 moves to step 2220. In step 2220, the selected entry is excluded from the selected cluster. Once this is done, process 2200 then progresses to step 2215. In step 2215, process 2200 checks if there is another entry in the cluster. If there is another entry, process 2200 repeats from step 2205 to step 2215 until all the entries in the selected cluster have been validated. Alternatively, if there are no further entries, process 2200 ends. The preselected program title used at step 2200 is left as a design choice to one skilled in the art.

Still yet another embodiment of the invention for verifying and validating entries in a selected cluster is illustrated in FIG. 23. Process 2300 is performed by a computer system in a server to validate the entries in a selected cluster. The validation process carried out by process 2300 allows for the generation of a user activity grid table that shows the timings at which a user spends transmitting and/or receiving data on a particular website/universal resource locator. Process 2300 begins at step 2305 by selecting an entry and by obtaining the record of the volume of data of that entry from the entries in the selected cluster. The obtained record of the volume of data is then compared with a minimum data volume threshold at step 2310. If process 2300 determines that the obtained record of the volume of data exceeds the minimum data volume threshold, process 2300 progresses to step 2315.

Alternatively, if process 2300 determines that the obtained record of the volume of data does not exceed the minimum data volume threshold, process 2300 moves to step 2320. In step 2320, the selected entry is excluded from the selected cluster. Once this is done, process 2300 then progresses to step 2315. In step 2315, process 2300 checks if there is another entry in the cluster. If there is another entry, process 2300 repeats step 2305 to step 2315 until all the entries in the selected cluster have been validated. Alternatively, if there are no further entries, process 2300 ends. The minimum data volume threshold used at step 2300 is left as a design choice to one skilled in the art.

FIG. 24 illustrates process 2400 that is performed by a computer system in a server to mark the grid of the table based on the validated entries in a linked cluster in accordance with embodiments of this invention. Process 2400 begins in step 2405 whereby a validated entry in the linked cluster is selected. The timestamp associated with this entry is obtained and matched with a timeslot on the table in step 2410. The timeslot that matches the obtained timestamp is then marked by process 2400 in step 2415. As previously discussed, the marking of the matching timeslot may be done using graduated tone marking methods such as a colorimetric marking method. Process 2400 progresses to step 2405 and checks if there is another validated entry in the linked cluster if not, process 2400 ends. Alternatively, if another new validated entry is present, steps 2410-2405 are repeated until all the entries have undergone process 2400. Process 2400 then ends.

In accordance with some embodiments of the invention, in addition to generating and displaying a user activity grid table, the system may also further generate and display a map to visually represent the geographical locations that correspond to certain events. FIG. 25 illustrates process 2500 that is performed by a computer system in a server to select a map and to plot geographical locations corresponding to validated entries having latitudinal and longitudinal coordinates on the selected map in accordance with some embodiments of this invention.

Process 2500 may be applied to validated entries in a cluster whereby the cluster is associated with a range of latitudinal and longitudinal coordinates. An example of such a cluster would be Cluster1 as illustrated in FIG. 5. Process 2500 begins in step 2505 by selecting a map that displays a geographical range or a latitudinal and longitudinal range that corresponds to the latitudinal and longitudinal range of the selected cluster. Process 2500 selects a validated entry from the selected cluster in step 2510. In step 2515, process 2500 obtains the longitudinal and latitudinal coordinate associated with the selected entry and plots the longitudinal and latitudinal coordinate on a corresponding geographical location on the map. Process 2500 then moves to step 2520 and selects the next validated entry in the selected cluster. Process 2500 determines in step 2510 whether another new validated entry is available for selection. If not, process 2500 ends. The plotting of the relevant coordinates on the map may be done using graduated tone marking methods such as a colorimetric marking method.

Alternatively, if process 2500 is able to select another new validated entry, steps 2515 to 2510 repeat until all the longitudinal and latitudinal coordinates corresponding to all the validated entries have been plotted on the map. Process 2500 then ends.

In accordance with embodiments of the invention, in addition to generating and displaying a user activity grid table as described above, the system may also generate a user activity grid table that is unique and tailored to a particular user. In such an embodiment, with reference to FIG. 16, process 1600 similarly begins by first retrieving N entries from a server at step 1601. Each of the entries retrieved from the server includes an event and a timestamp associated with the event. In this embodiment, in addition to each event having a latitudinal and longitudinal coordinate as previously disclosed with regard to FIG. 3a, each event also includes a mobile number as illustrated in FIG. 3b. Before process 1600 progresses to step 1605, these entries first undergo process 2600 as illustrated in FIG. 26.

FIG. 26 illustrates process 2600 that is performed by a computer system in a server to segregate the retrieved entries into groups in accordance with embodiments of this invention. Process 2600 begins in step 2605 by sequentially selecting an entry from the retrieved plurality of entries. In this step, process 2600 checks whether the selected entry is the last entry. If this entry is not the last entry, process 2600 progresses to step 2610. In step 2610, process 2600 obtains the mobile number associated with the selected entry. The obtained mobile number is compared in step 2615 with a mobile number of existing groups to determine if the obtained mobile number matches the mobile number associated with any of these groups. If the obtained mobile number does not match the mobile number of any existing group, the obtained number is deemed to be unique. When this occurs, process 2600 creates a new group in step 2620. The entry associated with the obtained number is then grouped into the newly created group in step 2625 and the mobile number is allocated to that group. Process 2600 then sequentially selects the next entry in step 2626.

Alternatively, if the obtained number matches the number corresponding to an existing group, the obtained number is deemed to be not unique. The entry associated with the obtained number is then grouped into the existing group in step 2630. Similarly, process 2600 then sequentially selects the next entry in step 2626.

Process 2600 then repeats steps 2605-2626 until all the entries have been segregated into groups. Once all the entries have been segregated, process 2600 then proceeds to step 2635 where the system will select a group of entries based on the group's associated mobile number. The entries belonging to the other groups will then be excluded leaving behind only entries belonging to the selected group. These entries will then be processed in accordance with steps 1605-1626 as previously described. Process 2600 then ends. One skilled in the art will recognize that the entries produced as a result of process 2600 may also undergo processes 1700, 1800, 1900, 2000, 2400 and 2500 as previously described.

In accordance with embodiments of the invention, processes 1505-1525 in FIG. 15 may be repeated any number of times to generate any number of user activity grid tables as required. Each user activity grid table may be linked with a different cluster allowing the various habits and subsequently the persona of the user to be graphically displayed and analysed.

Further, each of the generated activity grid tables associated with a range of latitudinal and longitudinal coordinates may be compared with a geographical database to ascertain the possible type of activity that may be associated with that particular range of latitudinal and longitudinal coordinates. For example, the system may check the geographical database to determine the geographical location that a range of latitudinal and longitudinal coordinates between (X₁-X₅,Y₁-Y₅) corresponds to. In this example, the geographical database may state that this range corresponds to the central business district of a particular city. Further, if the generated activity grid table shows that the user or plurality of users is at this location between 9 am-7 pm on Mondays to Fridays only, this would imply that the user or plurality of users works at the central business district.

In other words, by combining the generated activity grid tables with external databases, the persona of a particular individual or the personas of a plurality of individuals may be formed and analysed.

The above is a description of embodiments of a system and process in accordance with the present invention as set forth in the following claims. It is envisioned that others may and will design alternatives that fall within the scope of the following claims.

1. A method for generating and displaying a user activity grid table using a computing system comprising:
generating a first table having a plurality of grids, wherein each grid represents a timeslot, each timeslot having a day component and a time component;
selecting a first set of validated entries wherein each entry of this first set of validated entries comprises a timestamp, each timestamp having a day component and a time component;
linking the selected first set of validated entries to the first table;
marking grids in the first table that match with timestamps of each of the linked first set of validated entries, wherein the grids are marked using a graduated tone marking schema; and
displaying the first table.

2. The method of claim 1 wherein the selecting the first set of validated entries comprises:
retrieving a first set of entries from a server, wherein each entry in the first set of entries comprises a latitudinal and longitudinal coordinate and a timestamp;
grouping each entry in the first set of entries into one of a plurality of clusters according to the latitudinal and longitudinal coordinate of each entry, wherein each of the plurality of clusters is associated with a range of latitudinal and longitudinal coordinates;
selecting one of the plurality of clusters; and
verifying each entry in the selected one of the plurality of clusters and validating each verified entry.

3. The method of claim 2 further comprising:
selecting a map from a database, wherein a range of latitudinal and longitudinal coordinates on the map corresponds to the range of latitudinal and longitudinal coordinates associated with the selected one of the plurality of clusters;
plotting the latitudinal and longitudinal coordinates of validated entries on the map; and
displaying the map.

4. The method of claim 3 wherein the latitudinal and longitudinal coordinates of validated entries are plotted on the map using a colorimetric plotting schema.

5. The method of claim 2 wherein the grouping each entry in the first set of entries comprise:
selecting an entry from the first set of entries;
obtaining a latitudinal and longitudinal coordinate corresponding to the selected entry; and
determining whether the obtained latitudinal and longitudinal coordinate matches a latitudinal and longitudinal coordinate range associated with one of the plurality of clusters; and
associating the selected entry with the existing cluster in response to a determination of a match between the obtained latitudinal and longitudinal coordinate and the latitudinal and longitudinal coordinate range associated with the cluster.

6. The method of claim 2 wherein the verifying each entry in the selected one of the plurality of clusters comprise:
grouping the entries into timestamp groups; and
determining the validity of the timestamp groups.

7. The method of claim 6 wherein the grouping the entries into timestamp groups comprise:
selecting an entry from the cluster;
obtaining a timestamp corresponding to the selected entry; and
determining whether the obtained timestamp matches a timestamp range of a timestamp group; and
associating the selected entry with the timestamp group in response to a determination of a match between the obtained timestamp and the timestamp range of the timestamp group.

8. The method of claim 6 wherein the determining the validity of the timestamp groups comprise:
selecting a timestamp group;
determining whether the number of entries in the selected timestamp group exceeds a minimum number threshold; and
validating entries in the timestamp group in response to a determination the number of entries in the selected timestamp group exceeds the minimum number threshold.

9. The method of claim 2 wherein the verifying each entry in the selected one of the plurality of clusters comprise:
a. selecting an entry from the linked cluster;
b. obtaining a record of cellular data usage corresponding to the selected entry;
c. determining whether the record of cellular data usage exceeds a minimum data usage threshold;
d. validating the entry in response to a determination the record of cellular data usage exceeds the minimum data usage threshold; and
e. repeating steps (a) to (d) until all the entries in the cluster have been verified.

10. The method of claim 2 wherein the verifying each entry in the selected one of the plurality of clusters comprise:
a. selecting an entry from the linked cluster;
b. obtaining a record of short message service usage corresponding to the selected entry;
c. determining whether the record of short message service usage exceeds a minimum short message service usage threshold;
d. validating the entry in response to a determination the record of short message service usage exceeds the minimum short message service usage threshold; and
e. repeating steps (a) to (d) until all the entries in the cluster have been verified.

11. The method of claim 2 wherein the verifying each entry in the selected one of the plurality of clusters comprise:
a. selecting an entry from the linked cluster;
b. obtaining a record of voice usage corresponding to the selected entry;
c. determining whether the record of voice usage exceeds a minimum voice usage threshold;
d. validating the entry in response to a determination the record of voice usage exceeds the minimum voice usage threshold; and
e. repeating steps (a) to (d) until all the entries in the cluster have been verified.

12. The method of claim 2 wherein the retrieving the first set of entries from the server comprises:
segregating each entry in the first set of entries into one of a plurality of groups according to a mobile number of each entry, wherein each of the plurality of groups is associated with a mobile number;
selecting one of the plurality of groups that corresponds to a first mobile number; and
excluding the other groups from the first set of entries.

13. The method of claim 1 wherein the selecting the first set of validated entries comprises:
retrieving a first set of entries from a server, wherein each entry in the first set of entries comprises a channel and a timestamp;
grouping each entry in the first set of entries into one of a plurality of clusters according to the channel of each entry, wherein each of the plurality of clusters is associated with a channel;
selecting one of the plurality of clusters; and
verifying each entry in the selected one of the plurality of clusters and validating each verified entry.

14. The method of claim 13 wherein the grouping each entry in the first set of entries comprise:
selecting an entry from the first set of entries;
obtaining a channel corresponding to the selected entry; and
determining whether the obtained channel matches a channel associated with one of the plurality of clusters; and
associating the selected entry with the existing cluster in response to a determination of a match between the obtained channel and the channel associated with the cluster.

15. The method of claim 13 wherein the verifying each entry in the selected one of the plurality of clusters comprise:
grouping the entries into timestamp groups; and
determining the validity of the timestamp groups.

16. The method of claim 15 wherein the grouping the entries into timestamp groups comprise:
selecting an entry from the cluster;
obtaining a timestamp corresponding to the selected entry;
determining whether the obtained timestamp matches a timestamp range of a timestamp group; and
associating the selected entry with the timestamp group in response to a determination of a match between the obtained timestamp and the timestamp range of the timestamp group.

17. The method of claim 15 wherein the determining the validity of the timestamp groups comprise:
selecting a timestamp group;
determining whether the number of entries in the selected timestamp group exceeds a minimum number threshold; and
validating entries in the timestamp group in response to a determination the number of entries in the selected timestamp group exceeds the minimum number threshold.

18. The method of claim 13 wherein the verifying each entry in the selected one of the plurality of clusters comprise:
a. selecting an entry from the linked cluster;
b. obtaining a record of program language corresponding to the selected entry;
c. determining whether the record of the program language matches a first program language;
d. validating the entry in response to a determination the program language matches the first program language; and
e. repeating steps (a) to (d) until all the entries in the cluster have been verified.

19. The method of claim 13 wherein the verifying each entry in the selected one of the plurality of clusters comprise:
a. selecting an entry from the linked cluster;
b. obtaining a record of a title corresponding to the selected entry;
c. determining whether the record of the title matches a first title;
d. validating the entry in response to a determination the record of the title matches the first title; and
e. repeating steps (a) to (d) until all the entries in the cluster have been verified.

20. The method of claim 1 wherein the selecting the first set of validated entries comprises:
retrieving a first set of entries from a server, wherein each entry in the first set of entries comprises a universal resource locator and a timestamp;
grouping each entry in the first set of entries into one of a plurality of clusters according to the universal resource locator of each entry, wherein each of the plurality of clusters is associated with a universal resource locator;
selecting one of the plurality of clusters; and
verifying each entry in the selected one of the plurality of clusters and validating each verified entry.

21. The method of claim 20 wherein the grouping each entry in the first set of entries comprise:
selecting an entry from the first set of entries;
obtaining a universal resource locator corresponding to the selected entry;
determining whether the obtained universal resource locator matches a universal resource locator associated with one of the plurality of clusters; and
associating the selected entry with the existing cluster in response to a determination of a match between the obtained universal resource locator and the universal resource locator associated with the cluster.

22. The method of claim 20 wherein the verifying each entry in the selected one of the plurality of clusters comprise:
grouping the entries into timestamp groups; and
determining the validity of the timestamp groups.

23. The method of claim 22 wherein the grouping the entries into timestamp groups comprise:
selecting an entry from the cluster;
obtaining a timestamp corresponding to the selected entry; and
determining whether the obtained timestamp matches a timestamp range of a timestamp group; and
associating the selected entry with the timestamp group in response to a determination of a match between the obtained timestamp and the timestamp range of the timestamp group.

24. The method of claim 22 wherein the determining the validity of the timestamp groups comprise:
selecting a timestamp group;
determining whether the number of entries in the selected timestamp group exceeds a minimum number threshold; and
validating entries in the timestamp group in response to a determination the number of entries in the selected timestamp group exceeds the minimum number threshold.

25. The method of claim 20 wherein the verifying each entry in the selected one of the plurality of clusters comprise:
a. selecting an entry from the linked cluster;
b. obtaining a record of data volume corresponding to the selected entry;
c. determining whether the record of the data volume exceeds a minimum data volume threshold;
d. validating the entry in response to a determination the data volume exceeds the minimum data volume threshold; and
e. repeating steps (a) to (d) until all the entries in the cluster have been verified.

26. The method of claim 1 further comprising:
generating and displaying a second table having a plurality of grids, wherein each grid represents a timeslot, each timeslot having a day component and a time component;
selecting a second set of validated entries wherein each entry of this second set of validated entries comprises a timestamp, each timestamp having a day component and a time component;
linking the selected second set of validated entries to the second table; and
marking grids in the second table that match with timestamps of each of the linked second set of validated entries, wherein the grids are marked using a graduated tone marking schema.

27. The method of claim 1 wherein the graduated tone marking schema comprises a colorimetric marking scheme.

28. The method of claim 2 further comprising:
identifying a location of the selected cluster by comparing the range of the latitudinal and longitudinal coordinates associated with the selected cluster to geographical records contained within a geographical map database; and
determining an activity associated with the selected cluster based on the timestamps of the validated entries.

29. A system for generating and displaying a user activity grid table comprising:
instructions for directing a processing unit to:
generate a first table having a plurality of grids, wherein each grid represents a timeslot, each timeslot having a day component and a time component;
select a first set of validated entries wherein each entry of this first set of validated entries comprises a timestamp, each timestamp having a day component and a time component;
link the selected first set of validated entries to the first table;
mark grids in the first table that match with timestamps of each of the linked first set of validated entries, wherein the grids are marked using a graduated tone marking schema; and
display the first table.

30. The system of claim 29 wherein the instructions to select the first set of validated entries comprises:
instructions for directing the processing unit to:
retrieve a first set of entries from a server, wherein each entry in the first set of entries comprises a latitudinal and longitudinal coordinate and a timestamp;
group each entry in the first set of entries into one of a plurality of clusters according to the latitudinal and longitudinal coordinate of each entry, wherein each of the plurality of clusters is associated with a range of latitudinal and longitudinal coordinates;
select one of the plurality of clusters; and
verify each entry in the selected one of the plurality of clusters and validate each verified entry.

31. The system of claim 30 wherein the instructions further comprise instructions for directing the processing unit to:
select a map from a database, wherein a range of latitudinal and longitudinal coordinates on the map corresponds to the range of latitudinal and longitudinal coordinates associated with the selected one of the plurality of clusters;
plot the latitudinal and longitudinal coordinates of validated entries on the map; and
display the map.

32. The system of claim 31 wherein the latitudinal and longitudinal coordinates of validated entries are plotted on the map using a colorimetric plotting schema.

33. The system of claim 30 wherein the instructions to group each entry in the first set of entries comprise:
instructions for directing the processing unit to:
select an entry from the first set of entries;
obtain a latitudinal and longitudinal coordinate corresponding to the selected entry; and
determine whether the obtained latitudinal and longitudinal coordinate matches a latitudinal and longitudinal coordinate range associated with one of the plurality of clusters; and
associate the selected entry with the existing cluster in response to a determination of a match between the obtained latitudinal and longitudinal coordinate and the latitudinal and longitudinal coordinate range associated with the cluster.

34. The system of claim 30 wherein the instructions to verify each entry in the selected one of the plurality of clusters comprise:
instructions for directing the processing unit to:
group the entries into timestamp groups; and
determine the validity of the timestamp groups.

35. The system of claim 34 wherein the instructions to group the entries into timestamp groups comprise:
instructions for directing the processing unit to:
select an entry from the cluster;
obtain a timestamp corresponding to the selected entry; and
determine whether the obtained timestamp matches a timestamp range of a timestamp group; and
associate the selected entry with the timestamp group in response to a determination of a match between the obtained timestamp and the timestamp range of the timestamp group.

36. The system of claim 34 wherein the instructions to determine the validity of the timestamp groups comprise:
instructions for directing the processing unit to:
select a timestamp group;
determine whether the number of entries in the selected timestamp group exceeds a minimum number threshold; and
validate entries in the timestamp group in response to a determination the number of entries in the selected timestamp group exceeds the minimum number threshold.

37. The system of claim 30 wherein the instructions to verify each entry in the selected one of the plurality of clusters comprise:
instructions for directing the processing unit to:
a. select an entry from the linked cluster;
b. obtain a record of cellular data usage corresponding to the selected entry;
c. determine whether the record of cellular data usage exceeds a minimum data usage threshold;
d. validate the entry in response to a determination the record of cellular data usage exceeds the minimum data usage threshold; and
e. repeat steps (a) to (d) until all the entries in the cluster have been verified.

38. The system of claim 30 wherein the instructions to verify each entry in the selected one of the plurality of clusters comprise:
instructions for directing the processing unit to:
a. select an entry from the linked cluster;
b. obtain a record of short message service usage corresponding to the selected entry;
c. determine whether the record of short message service usage exceeds a minimum short message service usage threshold;
d. validate the entry in response to a determination the record of short message service usage exceeds the minimum short message service usage threshold; and
e. repeat steps (a) to (d) until all the entries in the cluster have been verified.

39. The system of claim 30 wherein the instructions to verify each entry in the selected one of the plurality of clusters comprise:
instructions for directing the processing unit to:
a. select an entry from the linked cluster;
b. obtain a record of voice usage corresponding to the selected entry;
c. determine whether the record of voice usage exceeds a minimum voice usage threshold;
d. validate the entry in response to a determination the record of voice usage exceeds the minimum voice usage threshold; and
e. repeat steps (a) to (d) until all the entries in the cluster have been verified.

40. The system of claim 30 wherein the instructions to retrieve the first set of entries from the server comprises:
instructions for directing the processing unit to:
segregate each entry in the first set of entries into one of a plurality of groups according to a mobile number of each entry, wherein each of the plurality of groups is associated with a mobile number;
select one of the plurality of groups that corresponds to a first mobile number; and
exclude the other groups from the first set of entries.

41. The system of claim 29 wherein the instructions to select the first set of validated entries comprises:
instructions for directing the processing unit to:
retrieve a first set of entries from a server, wherein each entry in the first set of entries comprises a channel and a timestamp;
group each entry in the first set of entries into one of a plurality of clusters according to the channel of each entry, wherein each of the plurality of clusters is associated with a channel;
select one of the plurality of clusters; and
verify each entry in the selected one of the plurality of clusters and validate each verified entry.

42. The system of claim 41 wherein the instructions to group each entry in the first set of entries comprise:
instructions for directing the processing unit to:
select an entry from the first set of entries;
obtain a channel corresponding to the selected entry; and
determine whether the obtained channel matches a channel associated with one of the plurality of clusters; and
associate the selected entry with the existing cluster in response to a determination of a match between the obtained channel and the channel associated with the cluster.

43. The system of claim 41 wherein the instructions to verify each entry in the selected one of the plurality of clusters comprise:
instructions for directing the processing unit to:
group the entries into timestamp groups; and
determine the validity of the timestamp groups.

44. The system of claim 43 wherein the instructions to group the entries into timestamp groups comprise:
instructions for directing the processing unit to:
select an entry from the cluster;
obtain a timestamp corresponding to the selected entry;
determine whether the obtained timestamp matches a timestamp range of a timestamp group; and
associate the selected entry with the timestamp group in response to a determination of a match between the obtained timestamp and the timestamp range of the timestamp group.

45. The system of claim 43 wherein the instructions to determine the validity of the timestamp groups comprise:
instructions for directing the processing unit to:
select a timestamp group;
determine whether the number of entries in the selected timestamp group exceeds a minimum number threshold; and
validate entries in the timestamp group in response to a determination the number of entries in the selected timestamp group exceeds the minimum number threshold.

46. The system of claim 41 wherein the instructions to verify each entry in the selected one of the plurality of clusters comprise:
instructions for directing the processing unit to:
a. select an entry from the linked cluster;
b. obtain a record of program language corresponding to the selected entry;
c. determine whether the record of the program language matches a first program language;
d. validate the entry in response to a determination the program language matches the first program language; and
e. repeat steps (a) to (d) until all the entries in the cluster have been verified.

47. The system of claim 41 wherein the instructions to verify each entry in the selected one of the plurality of clusters comprise:
instructions for directing the processing unit to:
a. select an entry from the linked cluster;
b. obtain a record of a title corresponding to the selected entry;
c. determine whether the record of the title matches a first title;
d. validate the entry in response to a determination the record of the title matches the first title; and
e. repeat steps (a) to (d) until all the entries in the cluster have been verified.

48. The system of claim 29 wherein the instructions to select the first set of validated entries comprises:
instructions for directing the processing unit to:
retrieve a first set of entries from a server, wherein each entry in the first set of entries comprises a universal resource locator and a timestamp;
group each entry in the first set of entries into one of a plurality of clusters according to the universal resource locator of each entry, wherein each of the plurality of clusters is associated with a universal resource locator;
select one of the plurality of clusters; and
verify each entry in the selected one of the plurality of clusters and validate each verified entry.

49. The system of claim 48 wherein the instructions to group each entry in the first set of entries comprise:
instructions for directing the processing unit to:
select an entry from the first set of entries;
obtain a universal resource locator corresponding to the selected entry;
determine whether the obtained universal resource locator matches a universal resource locator associated with one of the plurality of clusters; and
associate the selected entry with the existing cluster in response to a determination of a match between the obtained universal resource locator and the universal resource locator associated with the cluster.

50. The system of claim 48 wherein the instructions to verify each entry in the selected one of the plurality of clusters comprise:
instructions for directing the processing unit to:
group the entries into timestamp groups; and
determine the validity of the timestamp groups.

51. The system of claim 50 wherein the instructions to group the entries into timestamp groups comprise:
instructions for directing the processing unit to:
select an entry from the cluster;
obtain a timestamp corresponding to the selected entry; and
determine whether the obtained timestamp matches a timestamp range of a timestamp group; and
associate the selected entry with the timestamp group in response to a determination of a match between the obtained timestamp and the timestamp range of the timestamp group.

52. The system of claim 50 wherein the instructions to determine the validity of the timestamp groups comprise:
instructions for directing the processing unit to:
select a timestamp group;
determine whether the number of entries in the selected timestamp group exceeds a minimum number threshold; and
validate entries in the timestamp group in response to a determination the number of entries in the selected timestamp group exceeds the minimum number threshold.

53. The system of claim 48 wherein the instructions to verify each entry in the selected one of the plurality of clusters comprise:
instructions for directing the processing unit to:
a. select an entry from the linked cluster;
b. obtain a record of data volume corresponding to the selected entry;
c. determine whether the record of the data volume exceeds a minimum data volume threshold;
d. validate the entry in response to a determination the data volume exceeds the minimum data volume threshold; and
e. repeat steps (a) to (d) until all the entries in the cluster have been verified.

54. The system of claim 29 wherein the instructions further comprise:
instructions for directing the processing unit to:
generate and display a second table having a plurality of grids, wherein each grid represents a timeslot, each timeslot having a day component and a time component;
select a second set of validated entries wherein each entry of this second set of validated entries comprises a timestamp, each timestamp having a day component and a time component;
link the selected second set of validated entries to the second table; and
mark grids in the second table that match with timestamps of each of the linked second set of validated entries, wherein the grids are marked using a graduated tone marking schema.

55. The system of claim 29 wherein the graduated tone marking schema comprises a colorimetric marking scheme.

56. The system of claim 30 wherein the instructions further comprise:
instructions for directing the processing unit to:
identify a location of the selected cluster by comparing the range of the latitudinal and longitudinal coordinates associated with the selected cluster to geographical records contained within a geographical map database; and
determine an activity associated with the selected cluster based on the timestamps of the validated entries.

57. A system for generating and displaying a user activity grid table comprising:
circuitry in a server configured to generate a first table having a plurality of grids, wherein each grid represents a timeslot, each timeslot having a day component and a time component;
circuitry in a server configured to select a first set of validated entries wherein each entry of this first set of validated entries comprises a timestamp, each timestamp having a day component and a time component;
circuitry in a server configured to link the selected first set of validated entries to the first table;
circuitry in a server configured to mark grids in the first table that match with timestamps of each of the linked first set of validated entries, wherein the grids are marked using a graduated tone marking schema; and
circuitry in a server configured to display the first table.

58. The system of claim 57 wherein the circuitry in a server configured to select the first set of validated entries comprises:
circuitry in a server configured to retrieve a first set of entries from a server, wherein each entry in the first set of entries comprises a latitudinal and longitudinal coordinate and a timestamp;
circuitry in a server configured to group each entry in the first set of entries into one of a plurality of clusters according to the latitudinal and longitudinal coordinate of each entry, wherein each of the plurality of clusters is associated with a range of latitudinal and longitudinal coordinates;
circuitry in a server configured to select one of the plurality of clusters; and
circuitry in a server configured to verify each entry in the selected one of the plurality of clusters and validate each verified entry.

59. The system of claim 58 further comprising:
circuitry in a server configured to select a map from a database, wherein a range of latitudinal and longitudinal coordinates on the map corresponds to the range of latitudinal and longitudinal coordinates associated with the selected one of the plurality of clusters;
circuitry in a server configured to plot the latitudinal and longitudinal coordinates of validated entries on the map; and
circuitry in a server configured to display the map.

60. The system of claim 59 wherein the latitudinal and longitudinal coordinates of validated entries are plotted on the map using a colorimetric plotting schema.

61. The system of claim 58 wherein the circuitry in a server configured to group each entry in the first set of entries comprise:
circuitry in a server configured to select an entry from the first set of entries;
circuitry in a server configured to obtain a latitudinal and longitudinal coordinate corresponding to the selected entry; and
circuitry in a server configured to determine whether the obtained latitudinal and longitudinal coordinate matches a latitudinal and longitudinal coordinate range associated with one of the plurality of clusters; and
circuitry in a server configured to associate the selected entry with the existing cluster in response to a determination of a match between the obtained latitudinal and longitudinal coordinate and the latitudinal and longitudinal coordinate range associated with the cluster.

62. The system of claim 58 wherein the circuitry in a server configured to verify each entry in the selected one of the plurality of clusters comprise:
circuitry in a server configured to group the entries into timestamp groups; and
circuitry in a server configured to determine the validity of the timestamp groups.

63. The system of claim 62 wherein the circuitry in a server configured to group the entries into timestamp groups comprise:
circuitry in a server configured to select an entry from the cluster;
circuitry in a server configured to obtain a timestamp corresponding to the selected entry; and
circuitry in a server configured to determine whether the obtained timestamp matches a timestamp range of a timestamp group; and
circuitry in a server configured to associate the selected entry with the timestamp group in response to a determination of a match between the obtained timestamp and the timestamp range of the timestamp group.

64. The system of claim 62 wherein the circuitry in a server configured to determine the validity of the timestamp groups comprise:
circuitry in a server configured to select a timestamp group;
circuitry in a server configured to determine whether the number of entries in the selected timestamp group exceeds a minimum number threshold; and
circuitry in a server configured to validate entries in the timestamp group in response to a determination the number of entries in the selected timestamp group exceeds the minimum number threshold.

65. The system of claim 58 wherein the circuitry in a server configured to verify each entry in the selected one of the plurality of clusters comprise:
a. circuitry in a server configured to select an entry from the linked cluster;
b. circuitry in a server configured to obtain a record of cellular data usage corresponding to the selected entry;
c. circuitry in a server configured to determine whether the record of cellular data usage exceeds a minimum data usage threshold;
d. circuitry in a server configured to validate the entry in response to a determination the record of cellular data usage exceeds the minimum data usage threshold; and
e. circuitry in a server configured to repeat steps (a) to (d) until all the entries in the cluster have been verified.

66. The system of claim 58 wherein the circuitry in a server configured to verify each entry in the selected one of the plurality of clusters comprise:
a. circuitry in a server configured to select an entry from the linked cluster;
b. circuitry in a server configured to obtain a record of short message service usage corresponding to the selected entry;
c. circuitry in a server configured to determine whether the record of short message service usage exceeds a minimum short message service usage threshold;
d. circuitry in a server configured to validate the entry in response to a determination the record of short message service usage exceeds the minimum short message service usage threshold; and
e. circuitry in a server configured to repeat steps (a) to (d) until all the entries in the cluster have been verified.

67. The system of claim 58 wherein the circuitry in a server configured to verify each entry in the selected one of the plurality of clusters comprise:
a. circuitry in a server configured to select an entry from the linked cluster;
b. circuitry in a server configured to obtain a record of voice usage corresponding to the selected entry;
c. circuitry in a server configured to determine whether the record of voice usage exceeds a minimum voice usage threshold;
d. circuitry in a server configured to validate the entry in response to a determination the record of voice usage exceeds the minimum voice usage threshold; and
e. circuitry in a server configured to repeat steps (a) to (d) until all the entries in the cluster have been verified.

68. The system of claim 58 wherein the circuitry in a server configured to retrieve the first set of entries from the server comprises:
circuitry in a server configured to segregate each entry in the first set of entries into one of a plurality of groups according to a mobile number of each entry, wherein each of the plurality of groups is associated with a mobile number;
circuitry in a server configured to select one of the plurality of groups that corresponds to a first mobile number; and
circuitry in a server configured to exclude the other groups from the first set of entries.

69. The system of claim 57 wherein the circuitry in a server configured to select the first set of validated entries comprises:
circuitry in a server configured to retrieve a first set of entries from a server, wherein each entry in the first set of entries comprises a channel and a timestamp;
circuitry in a server configured to group each entry in the first set of entries into one of a plurality of clusters according to the channel of each entry, wherein each of the plurality of clusters is associated with a channel;
circuitry in a server configured to select one of the plurality of clusters; and
circuitry in a server configured to verify each entry in the selected one of the plurality of clusters and validate each verified entry.

70. The system of claim 69 wherein the circuitry in a server configured to group each entry in the first set of entries comprise:
circuitry in a server configured to select an entry from the first set of entries;
circuitry in a server configured to obtain a channel corresponding to the selected entry; and
circuitry in a server configured to determine whether the obtained channel matches a channel associated with one of the plurality of clusters; and
circuitry in a server configured to associate the selected entry with the existing cluster in response to a determination of a match between the obtained channel and the channel associated with the cluster.

71. The system of claim 69 wherein the circuitry in a server configured to verify each entry in the selected one of the plurality of clusters comprise:
circuitry in a server configured to group the entries into timestamp groups; and
circuitry in a server configured to determine the validity of the timestamp groups.

72. The system of claim 71 wherein the circuitry in a server configured to group the entries into timestamp groups comprise:
circuitry in a server configured to select an entry from the cluster;
circuitry in a server configured to obtain a timestamp corresponding to the selected entry;
circuitry in a server configured to determine whether the obtained timestamp matches a timestamp range of a timestamp group; and
circuitry in a server configured to associate the selected entry with the timestamp group in response to a determination of a match between the obtained timestamp and the timestamp range of the timestamp group.

73. The system of claim 71 wherein the circuitry in a server configured to determine the validity of the timestamp groups comprise:
circuitry in a server configured to select a timestamp group;
circuitry in a server configured to determine whether the number of entries in the selected timestamp group exceeds a minimum number threshold; and
circuitry in a server configured to validate entries in the timestamp group in response to a determination the number of entries in the selected timestamp group exceeds the minimum number threshold.

74. The system of claim 69 wherein the circuitry in a server configured to verify each entry in the selected one of the plurality of clusters comprise:
a. circuitry in a server configured to select an entry from the linked cluster;
b. circuitry in a server configured to obtain a record of program language corresponding to the selected entry;
c. circuitry in a server configured to determine whether the record of the program language matches a first program language;
d. circuitry in a server configured to validate the entry in response to a determination the program language matches the first program language; and
e. circuitry in a server configured to repeat steps (a) to (d) until all the entries in the cluster have been verified.

75. The system of claim 69 wherein the circuitry in a server configured to verify each entry in the selected one of the plurality of clusters comprise:
a. circuitry in a server configured to select an entry from the linked cluster;
b. circuitry in a server configured to obtain a record of a title corresponding to the selected entry;
c. circuitry in a server configured to determine whether the record of the title matches a first title;
d. circuitry in a server configured to validate the entry in response to a determination the record of the title matches the first title; and
e. circuitry in a server configured to repeat steps (a) to (d) until all the entries in the cluster have been verified.

76. The system of claim 57 wherein the circuitry in a server configured to select the first set of validated entries comprises:
circuitry in a server configured to retrieve a first set of entries from a server, wherein each entry in the first set of entries comprises a universal resource locator and a timestamp;
circuitry in a server configured to group each entry in the first set of entries into one of a plurality of clusters according to the universal resource locator of each entry, wherein each of the plurality of clusters is associated with a universal resource locator;
circuitry in a server configured to select one of the plurality of clusters; and
circuitry in a server configured to verify each entry in the selected one of the plurality of clusters and validate each verified entry.

77. The system of claim 76 wherein the circuitry in a server configured to group each entry in the first set of entries comprise:
circuitry in a server configured to select an entry from the first set of entries;
circuitry in a server configured to obtain a universal resource locator corresponding to the selected entry;
circuitry in a server configured to determine whether the obtained universal resource locator matches a universal resource locator associated with one of the plurality of clusters; and
circuitry in a server configured to associate the selected entry with the existing cluster in response to a determination of a match between the obtained universal resource locator and the universal resource locator associated with the cluster.

78. The system of claim 76 wherein the circuitry in a server configured to verify each entry in the selected one of the plurality of clusters comprise:
circuitry in a server configured to group the entries into timestamp groups; and
circuitry in a server configured to determine the validity of the timestamp groups.

79. The system of claim 78 wherein the circuitry in a server configured to group the entries into timestamp groups comprise:
circuitry in a server configured to select an entry from the cluster;
circuitry in a server configured to obtain a timestamp corresponding to the selected entry; and
circuitry in a server configured to determine whether the obtained timestamp matches a timestamp range of a timestamp group; and
circuitry in a server configured to associate the selected entry with the timestamp group in response to a determination of a match between the obtained timestamp and the timestamp range of the timestamp group.

80. The system of claim 78 wherein the circuitry in a server configured to determine the validity of the timestamp groups comprise:
circuitry in a server configured to select a timestamp group;
circuitry in a server configured to determine whether the number of entries in the selected timestamp group exceeds a minimum number threshold; and
circuitry in a server configured to validate entries in the timestamp group in response to a determination the number of entries in the selected timestamp group exceeds the minimum number threshold.

81. The system of claim 76 wherein the circuitry in a server configured to verify each entry in the selected one of the plurality of clusters comprise:
a. circuitry in a server configured to select an entry from the linked cluster;
b. circuitry in a server configured to obtain a record of data volume corresponding to the selected entry;
c. circuitry in a server configured to determine whether the record of the data volume exceeds a minimum data volume threshold;
d. circuitry in a server configured to validate the entry in response to a determination the data volume exceeds the minimum data volume threshold; and
e. circuitry in a server configured to repeat steps (a) to (d) until all the entries in the cluster have been verified.

82. The system of claim 57 wherein further comprising:
circuitry in a server configured to generate and display a second table having a plurality of grids, wherein each grid represents a timeslot, each timeslot having a day component and a time component;
circuitry in a server configured to select a second set of validated entries wherein each entry of this second set of validated entries comprises a timestamp, each timestamp having a day component and a time component;
circuitry in a server configured to link the selected second set of validated entries to the second table; and
circuitry in a server configured to mark grids in the second table that match with timestamps of each of the linked second set of validated entries, wherein the grids are marked using a graduated tone marking schema.

83. The system of claim 57 wherein the graduated tone marking schema comprises a colorimetric marking scheme.

84. The system of claim 58 further comprising:
circuitry in a server configured to identify a location of the selected cluster by comparing the range of the latitudinal and longitudinal coordinates associated with the selected cluster to geographical records contained within a geographical map database; and
circuitry in a server configured to determine an activity associated with the selected cluster based on the timestamps of the validated entries.
